(19) United States
(12) Patent Application Publication
(10) Pub. No.: US 2008/0043005 A1
(43) Pub. Date: Feb. 21, 2008

(54) ELECTRO-OPTICAL DEVICE AND ELECTRONIC APPARATUS

(75) Inventor: Eiji KANDA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/828,706

(22) Filed: Jul. 26, 2007

(30) Foreign Application Priority Data
Aug. 17, 2006 (JP) 2006-222292
Aug. 28, 2006 (JP) 2006-230184
Jun. 22, 2007 (JP) 2007-164683

(51) Int. Cl. G06F 3/038

(52) U.S. Cl. 345/204

(57) ABSTRACT

An electro-optical device may include a plurality of data lines, a plurality of selection lines, a plurality of unit circuits, a selection circuit, and a control circuit. Each of the plurality of unit circuits is connected to a corresponding one of the plurality of data lines and a corresponding one of the plurality of selection lines. The plurality of unit circuits form a unit circuit group for each of the selection lines. The selection circuit supplies a selection signal to one of the plurality of selection lines so that data signals are written from the plurality of data lines to the corresponding unit circuit group during a selection period when the corresponding unit circuit group is selected. The control circuit supplies a common control signal to the unit circuits included in a group consisting of two or more of the unit circuit groups. The control circuit brings the control signal into a predetermined state during a period that is different from the selection period when any one of the two or more unit circuit groups is selected. Here, each of the plurality of unit circuits includes an electro-optical element, a first switching element, a driving transistor. The first switching element writes the data signal from one of the plurality of data lines to the corresponding unit circuit in accordance with the selection signal. The gate of the driving transistor is supplied with a voltage corresponding to the data signal. The driving transistor supplies a driving current to the electro-optical element.

The entire disclosure of Japanese Patent Application Nos: 2006-222292, filed Aug. 17, 2006, 2006-230184, filed Aug. 28, 2006, and 2007-164683, filed Jun. 22, 2007 are expressly incorporated by reference herein.

### BACKGROUND

1. Technical Field

The present invention relates to a technology for controlling an electro-optical element, such as a light emitting element, and an electronic apparatus.

2. Related Art

It has been proposed in the existing art that an electro-optical device that uses transistors (hereinafter, referred to as “driving transistors”) for driving electro-optical elements. For example, in the electro-optical device that employs a light emitting element, such as an organic light emitting diode, as an electro-optical element, the electric potential of the gate of each driving transistor is set (data writing) in correspondence with a data signal that specifies a gray-scale level of the electro-optical element. Then, the electro-optical elements are driven by the supply of electric current flowing in the corresponding driving transistors.

In addition, prior to data writing, it has been studied that the configuration in which the electric potential of the gate of each driving transistor is initialized to a predetermined value. For example, U.S. Pat. No. 6,229,506 (particularly, in FIG. 3) or Japanese Unexamined Patent Application Publication No. 2004-70074 particularly in FIG. 2) describe a technology that a transistor (hereinafter, referred to as “compensating transistor”) connected between the gate and drain of the driving transistor is made into a conductive state prior to data writing and, thereby, the gate of the driving transistor is set to an electric potential corresponding to its own threshold voltage. According to this technology, variation in threshold voltages of the driving transistors is compensated. Furthermore, the above JP-A-2004-70074 also describes that a transistor (hereinafter, referred to as “reset transistor”) connected between the gate of the driving transistor and a power supply line is made into a conductive state prior to data writing and, thereby, the gate of the driving transistor is reset to a high level power supply potential.

Other various electro-optical devices have been proposed in the existing art in which a plurality of electro-optical elements are driven in time sharing. For example, Japanese Unexamined Patent Application Publication No. 2006-30516 (particularly, in FIG. 22) describes a display device in which a plurality of pixels are arranged in a matrix. Each of the pixels includes a driving transistor that generates driving current, a light emitting element that emits light owing to the supply of driving current, and a light emission control transistor that is connected between the driving transistor and the light emitting element. The light emission control transistor of each pixel is controlled in accordance with a light emission control signal that a driving circuit generates for each row of pixels.

However, in the configuration described in the U.S. Pat. No. 6,229,500 or in the JP-A-2004-70074, because each compensating transistor and each reset transistor are controlled in units of rows, it requires a large scale driving circuit that generates that generates the same number of signals as the number of rows of pixels for the compensating transistor and the reset transistor. In addition, in the configuration described in JP-A-2006-30516, it requires a large scale driving circuit that generates the same number of light emission control signals as the number of rows of pixels. Thus, there is a problem that it needs to ensure a large space for arranging the driving circuit around the array of the electro-optical elements (that is, it is difficult to reduce the width of the window frame). There is also a problem that a yield is reduced due to an increase in number of elements that form the driving circuit.

### SUMMARY

An advantage of some aspects of the invention is that it suppresses the size of a driving circuit.

Aspects or application examples of the invention may be implemented as follows,

### FIRST APPLICATION EXAMPLE

Ann electro-optical device may include a plurality of data lines, a plurality of selection lines, a plurality of unit circuits, a selection circuit, and a control circuit. Each of the plurality of unit circuits is connected to a corresponding one of the plurality of data lines and a corresponding one of the plurality of selection lines. The plurality of unit circuits form a unit circuit group for each of the selection lines. The selection circuit supplies a selection signal to one of the plurality of selection lines so that data signals are written from the plurality of data lines to the corresponding unit circuit group during a selection period when the corresponding unit circuit group is selected. The control circuit supplies a common control signal to the unit circuits included In a group consisting of two or more of the unit circuit groups. The control circuit brings the control signal into a predetermined state during a period that is different from the selection period when any one of the two or more unit circuit groups is selected. Here, each of the plurality of unit circuits includes an electro-optical element, a first switching element, a driving transistor. The first switching element writes the data signal from one of the plurality of data lines to the corresponding unit circuit in accordance with the selection signal. The gate of the driving transistor is supplied with a voltage corresponding to the data signal. The driving transistor supplies a driving current to the electro-optical element.

According to the first application example, owing to the control circuit, it is possible to commonly control the unit circuits included in a group consisting of two or more of the unit circuit groups. Thus, it is possible to simplify a control circuit that supplies a control signal. Hence, the size of the control circuit Is reduced.

### SECOND APPLICATION EXAMPLE

When the control signal is in the predetermined state, the states of the unit circuits prior to the selection period may be set.

According to the second application example, the states of unit circuits prior to the selection period are controlled in the unit circuits included in a group consisting of two or more of the unit circuit groups, it is possible to simplify a control circuit that supplies a control signal. Thus, the size of the control circuit is reduced. Here, the state of the unit circuit prior to a selection period includes, for example, a state where a previously written data signal is reset for initializing, a state where a value corresponding to the characteristics of a driving transistor is set in order to suppress variation in driving currents that may vary in accordance with characteristics, such as threshold values or mobility, of driving transistors in the unit circuits, a state where the electro-optical element is set not to emit light, or the like.

### THIRD APPLICATION EXAMPLE

Each of the unit circuits may further include a second switching element that sets a potential of the gate to a predetermined value when the control signal is in the predetermined state.

### FOURTH APPLICATION EXAMPLE

The second switching element may be electrically connected to a drain of the driving transistor with the gate of the driving transistor when the second switching element enters a conductive state.

### FIFTH APPLICATION EXAMPLE

In each of the unit circuits, the electro-optical element and the driving transistor may be connected in series in a line through which the driving current flows from a power source. In this case, each of the unit circuit includes a third switching element provided in a line connected to the power source and a logic circuit that outputs a logic signal based on the control signal and a drive control signal. The third switching element is controlled on the basis of the logic signal. Further in this case, the drive control signal is a signal that specifies a period during which a supply of the driving current corresponding to the written data signal to the electro-optical element is permitted or that specifies a period during which a supply of the driving current corresponding to the written data signal to the electro-optical element is prohibited.

According to the foregoing application examples, when an initialization signal is supplied and the unit circuit is initialized by the second switching element, it is possible to prevent a driving current from being supplied to the electro-optical element. Here, the third switching element may be provided to short-circuit a line connected to the power source after it enters a conductive state, or may be provided in parallel with the electro-optical element, or may be provided in series with the driving transistor and the electro-optical element in a line connected to the power source.

### SIXTH APPLICATION EXAMPLE

The electro-optical device may further include a regulator circuit that delays the logic signal relative to the control signal.

### SEVENTH APPLICATION EXAMPLE

The regulator circuit may include a predetermined number of buffers arranged in a line through which the control signal is supplied to the second switching element, and buffers, the number of which is greater than the predetermined number, arranged in a line through which the logic signal is supplied to the third switching element.

### EIGHTH APPLICATION EXAMPLE

The electro-optical device may further includes a power feed line through which a reset potential is supplied. Then, the second switching element may control electrical connection between the power feed line and the gate of the driving transistor.

### NINTH APPLICATION EXAMPLE

The unit circuit may further include a fourth switching element that electrically conducts a line between the electro-optical element and the gate of the driving transistor when the control signal is in the predetermined state.

According to the foregoing application examples, because “he control signal that controls the fourth switching element is supplied to the unit circuits included in a group consisting of two or more of the unit circuit groups, it is possible to simplify a control circuit that supplies a control signal and it is also possible to reduce the size of the control circuit. Here, the fourth switching element may be provided to short-circuit a line connected to the power source after it enters a conductive state, or may be provided in parallel with the electro-optical element, or may be provided in series with the driving transistor and the electro-optical element in a line connected to the power source to Interrupt a driving current.

### TENTH APPLICATION EXAMPLE

The electro-optical device may further include a logic circuit that outputs a logic signal based on the selection signal and the control signal, and the fourth switching element is controlled on the basis of the logic signal.

According to the foregoing application examples, the electro-optical element is prohibited to operate within a predetermined period that includes a period when the selection circuit selects the corresponding unit circuit. That is, it is possible to avoid that the electro-optical element initiates to operate when data signals are being written to the corresponding unit circuits. Thus, it is possible to control the electro-optical elements to desired gray-scale levels with high accuracy and to reduce the time required for writing the data signals to the corresponding unit circuits.

### ELEVENTH APPLICATION EXAMPLE

The electro-optical device may include a regulator circuit that delays the logic signal relative to the selection signal.

### TWELFTH APPLICATION EXAMPLE

The regulator circuit may include a predetermined number of buffers arranged in a line through which the selection signal is supplied to the first switching element, and buffers, the number of which is greater than the predetermined number, arranged in a line through which the logic signal is supplied to the fourth switching element.

### THIRTEENTH APPLICATION EXAMPLE

The electro-optical device may include a plurality of date lines, a plurality of selection lines, a plurality of unit circuits, and a control line. Each of the plurality of data lines is supplied with a data signal corresponding to a gray-scale level. Each of the plurality of selection lines is supplied with a selection signal. Each of the plurality of unit circuits is connected to a corresponding one of the plurality of data lines and a corresponding one of the plurality of selection lines. The plurality of unit circuits form a unit circuit group for each of the selection lines. The control line is commonly connected to the unit circuits included in a group consisting of two or more of the unit circuit groups. In this case, the selection signal specifies the selection period for each of the unit circuit groups so that the data signals are written to the corresponding unit circuit group within the selection period of the corresponding unit circuit group, and a control signal supplied to the control line is set to a predetermined state so that the two or more unit circuit groups are controlled during a period that is different from the period when any one of the two or more unit circuit groups are selected. Furthermore, each of the plurality of unit circuits includes an electro-optical element, a first switching element, and a driving transistor. The first switching element writes the data signal from one of the plurality of data lines to the corresponding unit circuit in accordance with the selection signal. The gate of the driving transistor is supplied with a voltage corresponding to the data signal. The driving transistor supplies a driving current to the electro-optical element.

According to the foregoing application examples, when the control signal is supplied to the common control line, it is possible to control unit circuits included in a group consisting of two or more of the unit circuit groups. Thus, it is possible to simplify a control circuit that supplies a control signal. Hence, the size of the control circuit is reduced.

### FOURTEENTH APPLICATION EXAMPLE

An electronic apparatus may include the above electro-optical device.

### FIFTEENTH APPLICATION EXAMPLE

An electro-optical device may include a plurality of data lines, a plurality of selection lines, a plurality of unit circuits, a selection circuit, and a control circuit. Each of the plurality of unit circuits is connected to a corresponding one of the plurality of data lines and a corresponding one of the plurality of selection lines. The plurality of unit circuits form a unit circuit group for each of the plurality of selection lines. The selection circuit supplies a selection signal to one of the plurality of selection lines so that a detection current is supplied from the corresponding unit circuit group to each of the plurality of data lines within a selection period when the corresponding unit circuit group is selected. The control circuit supplies a common control signal to the unit circuits included in a group consisting of two or more of the unit circuit groups. The control circuit brings the control signal into a predetermined state during a period that is different from the selection period when any one of the two or more unit circuit groups is selected. Here, each of the plurality of unit circuits includes an electro-optical element that generates an electrical signal corresponding to the amount of light received, a detecting transistor that outputs the detection current corresponding to the electrical signal, and a first switching element that supplies the detection current supplied from the detecting transistor to a corresponding one of the plurality of data lines in accordance with the selection signal.

According to the foregoing application examples, it is possible to commonly control unit circuits included in a group consisting of two or more of the unit circuit groups. Thus, it is possible to simplify a control circuit that supplies a control signal. Hence, the size of the control circuit is reduced.

### SIXTEENTH APPLICATION EXAMPLE

Each of the unit circuits may include a second switching element that electrically conducts a line between the electro-optical element and a gate of the detecting transistor when the control signal is in the predetermined state.

### SEVENTEENTH APPLICATION EXAMPLE

An electro-optical device may include a plurality of unit circuits, a selection circuit, and an initialization circuit. Each of the plurality of unit circuits includes a driving transistor and an initializing switching element. The driving transistor drives an electro-optical element in accordance with the potential of a gate thereof. The initializing switching element sets the potential of the gate of the driving transistor to a predetermined value when it enters a conductive state (on state). The selection circuit sequentially selects each of the plurality of unit circuits. The initialization circuit generates an initialization signal for each of a plurality of groups each including two or more of the unit circuits into which the plurality of unit circuits are separated. Here, the gate of the driving transistor of each unit circuit is set to have an electric potential corresponding to a data signal that is supplied when the corresponding unit circuit is selected by the selection circuit. In addition, each of the initializing switching elements of the two or more unit circuits that belong to each of the plurality of groups is brought into a conductive state in accordance with an initialization signal that the initialization circuit generates for the corresponding group prior to selection of the corresponding unit circuit by the selection circuit.

According to the foregoing application examples, because the plurality of initializing switching elements that belong to one group are controlled with the common initialization signal, the size of the initialization circuit is reduced in comparison with the existing configuration in which a signal for controlling the initializing switching element is separately generated for each of the plurality of unit circuits.

### EIGHTEENTH APPLICATION EXAMPLE

The initializing switching element may, for example, connect the gate of the driving transistor to the drain thereof when it enters a conductive state and may diode-connect the driving transistor. Since the gate of the driving transistor is set to have an electric potential corresponding to its own threshold voltage owing to the diode-connection, variation in threshold voltages of the driving transistors of the unit circuits is compensated. The initializing switching element in this application example may be a transistor QSW2 shown in FIG. 4, for example. In addition, the initialization circuit, for example, corresponds to a compensation control circuit 34 shown in FIG. 2, and the initialization signal, for example, corresponds to a compensation control signal GCP[k] shown in FIG. 2.

### NINETEENTH APPLICATION EXAMPLE

The initializing switching element may control electrical connection between a power feed line that is supplied with a reset potential and the gate of the driving transistor. According to the foregoing application examples, even when the potential of the gate of the driving transistor is accidentally fluctuated due to a noise, or the like, the gate of the driving transistor is initialized to a reset potential when the initializing switching element is brought into a conductive state. Therefore, it is advantageous in that malfunction of each unit circuit due to a noise, or the like, is prevented. The initializing switching element according to this application example may be a transistor QSW3 shown in FIG. 4, for example. In addition, the initialization circuit, for example, corresponds to a reset control circuit 36 shown in FIG. 2, and the initialization signal, for example, corresponds to a reset control signal GRS[k] shown in FIG. 2.

Incidentally, if the electro-optical element of the unit circuit initiates to operate during an initialization period when the initializing switching element of the unit circuit is in a conductive state, it may impede a desired operation of each unit circuit. For example, if the electro-optical element initiates to operate before the potential of the gate of the driving transistor converges on an electric potential corresponding to its own threshold voltage, variation in threshold voltages of the driving transistors is not effectively compensated. Furthermore, if the electro-optical element initiates to operate before the supply of reset potential to the gate of the driving transistor is completed, the electro-optical element cannot be driven to a desired gray-scale level.

### TWENTIETH APPLICATION EXAMPLE

Then, the electro-optical device may include a plurality of logic circuits (for example, a NAND circuit 50 shown in FIG. 7 or FIG. 9) provided in correspondence with the unit circuits and a drive control circuit that generates a drive control signal for each of the unit circuits. Here, each of the plurality of unit circuits includes a drive control switching element that permits the driving transistor to drive the electro-optical element or that prohibits the driving transistor from driving the electro-optical element in accordance with the control signal. Moreover, each of the plurality of logic circuits generates a control signal that specifies prohibition of operation of the electro-optical element during a predetermined period that includes a period during which the initializing switching element enters a conductive state on the basis of a drive control signal generated for each unit circuit and an initialization signal of a group to which the corresponding unit circuit belongs. According to the foregoing application example, the operation of the electro-optical element is prohibited during a predetermined period that includes an initialization period when the initializing switching element enters a conductive state. That is it is possible to avoid that the electro-optical element initiates to operate when the potential of the gate of the driving transistor is being initialized. Thus, it is possible for each unit circuit to reliably execute a desired operation.

Focusing particularly on a relationship between a period during which the initializing switching element is in a conductive state and a timing when the electro optical element initiates to operate as described above, the electro-optical device includes a driving transistor, a plurality of unit circuits, a selection circuit, an initialization circuit, and a plurality of logic circuits. The driving transistor drives the electro-optical element in accordance with the potential of the gate thereof. Each of the plurality of unit circuits includes an initializing switching element that sets the potential of the gate of the driving transistor to a predetermined value when it enters a conductive state. The selection circuit sequentially selects each of the plurality of unit circuits by outputting a selection signal to the unit circuit. The initialization circuit generates an initialization signal that controls the initializing switching element of each unit circuit. The plurality of logic circuits are provided in correspondence with the unit circuits. Here, the gate of the driving transistor of each unit circuit is set to have an electric potential corresponding to a data signal that is supplied when the selection circuit selects the corresponding unit circuit. In addition, the initializing switching element of each unit circuit is brought into a conductive state in accordance with an initialization signal generated by the initialization circuit before the selection circuit selects the corresponding unit circuit Then, each of the plurality of logic circuits generates a control signal that specifies prohibition of operation of the electro-optical element during a predetermined period that includes a period during which the initializing switching element enters a conductive state on the basis of a drive control signal and initialization signal that are generated for the corresponding unit circuit. Furthermore, a drive control switching element of each unit circuit enters a state corresponding to a control signal generated by the logic circuit corresponding to the unit circuit. In the foregoing application example, it is unnecessary to include a configuration for sharing a single initialization signal among the plurality of unit circuits.

### TWENTY-FIRST APPLICATION EXAMPLE

The electro-optical device may include a regulator circuit that delays a control signal supplied from the logic circuit to the corresponding unit circuit relative to an initialization signal supplied from the initialization circuit to the corresponding unit circuit. According to this application example, because the control signal is delayed relative to the initialization signal, it is possible to effectively prevent initiation of operation of the electro-optical element within the selection period.

### TWENTY-SECOND APPLICATION EXAMPLE

The regulator circuit according to the foregoing application examples may, for example, include a predetermined number of buffers arranged in a line through which the initialization circuit outputs an initialization signal, and buffers, the number of which is greater than the predetermined number, arranged in a line through which the logic circuit outputs a control signal.

### TWENTY-THIRD APPLICATION EXAMPLE

Can electro-optical device may include a plurality of unit circuits, a selection circuit, a drive control circuit. Each of the plurality of unit circuits includes an electro-optical element and a drive control switching element. The drive control switching element permits the electro-optical element to operate or prohibits the electro-optical element from operating. The selection circuit sequentially selects each of the plurality of unit circuits. The drive control circuit generates a drive control signal for each of the plurality of groups each including two or more of the unit circuits into which the plurality of unit circuits are separated. Here, the electro-optical element of each unit circuit is driven in accordance with a data signal that is supplied when the selection circuit selects the corresponding unit circuit. Then, the drive control switching element of each of the unit circuits that belong to each of the plurality of groups is brought into a state corresponding to a drive control signal that the drive control circuit outputs for the corresponding group.

According to the foregoing application example, because the plurality of drive control switching elements that belong to one group are controlled by a common drive control signal, the size of the drive control circuit is reduced in comparison with the existing configuration in which a signal for controlling the drive control switching element is separately generated for each of the plurality of unit circuits.

### TWENTY-FOURTH APPLICATION EXAMPLE

Each of the plurality of groups may include the same number of unit circuits. According to this application example, in comparison with the configuration in which the numbers of unit circuits that belong to the corresponding groups are different, it is advantageous in that the gray-scale levels of the plurality of electro-optical elements are visually uniform.

Incidentally, if the electro-optical element of each unit circuit initiates to operate within a selection period during which a data signal is supplied to the unit circuit, it is difficult to control the electro-optical element to a desired gray-scale level with high accuracy. In addition, there is also a problem that the amount of time required for appropriately writing ea data signal to the unit circuit is increased.

### TWENTY-FIFTH APPLICATION EXAMPLE

Then, the electro-optical device may include a plurality of logic circuits provided in correspondence with the unit circuits. Here, the selection circuit outputs a selection signal to each of the plurality of unit circuits. In addition, each of the plurality of logic circuits generates a control signal that specifies prohibition of operation of the electro-optical element during a predetermined period that includes a period during which the selection circuit selects the corresponding unit circuit on the basis of a selection signal output to the corresponding unit circuit and a drive control signal of a group to which the unit circuit belongs. Then, the drive control switching element of each unit circuit enters a state corresponding to the control signal that the logic circuit corresponding to the unit circuit generates.

According to the foregoing application example, the operation of the electro-optical element is prohibited within a predetermined period that includes a period during which the selection circuit selects the corresponding unit circuit. That is, it is possible to avoid that the electro-optical element initiates to operate when a data signal is being written to the corresponding unit circuit. Thus, it is possible to control the electro-optical element to a desired gray-scale level with high accuracy and to reduce the amount of time required for writing the data signal to the corresponding unit circuit.

Focusing particularly on a relationship between a selection period and a timing when the electro-optical element initiates to operate as described above, the electro-optical device includes a plurality of unit circuits, a selection circuit, a drive control circuit, and a plurality of logic circuits. Each of the plurality of unit circuits includes an electro-optical element and a drive control switching element. The drive control switching element permits the electro-optical element to operate or prohibits the electro-optical element from operating. The selection circuit sequentially selects each of the plurality of unit circuits by outputting a selection signal to the unit circuit. The drive control circuit generates a drive control signal that controls the drive control switching element of each unit circuit. The plurality of logic circuits are provided in correspondence with the unit circuits. Then, the electro-optical element of each unit circuit is driven in accordance with a data signal that is supplied when the selection circuit selects the corresponding unit circuit. Each of the logic circuits generates a control signal that specifies prohibition of operation of the electro-optical element during a predetermined period that includes a period when the selection circuit selects the corresponding unit circuit on the basis of the selection signal output to the corresponding unit circuit and the drive control signal that the drive control circuit generates for the corresponding unit circuit. Furthermore, a drive control switching element of each unit circuit enters a state corresponding to the control signal that the logic circuit corresponding to the unit circuit generates. In the foregoing application example, it is unnecessary to include a configuration for sharing a drive control signal among the plurality of unit circuits.

### TWENTY-SIXTH APPLICATION EXAMPLE

The electro-optical device may include a regulator circuit that delays a control signal supplied from the logic circuit to the corresponding unit circuit relative to a selection signal supplied from the selection circuit to the corresponding unit circuits. According to this application example, because the control signal is delayed relative to the selection signal, it is possible to effectively prevent initiation of operation of the electro-optical element within the selection period.

### TWENTY-SEVENTH APPLICATION EXAMPLE

The regulator circuit according to the foregoing application example may, for example, include a predetermined number of buffers arranged in a line through which the selection circuit outputs a selection signal, and buffers, the number of which is greater than the predetermined number, arranged in a line through which the logic circuit outputs a control signal.

### TWENTY-EIGHTH APPLICATION EXAMPLE

The electro-optical device may be used for various electronic apparatuses. A typical example of the electronic apparatus is a device that uses the electro-optical device as a display device. The electronic apparatus of this type includes a personal computer, a mobile telephone, and the like. However, applications of the electro-optical device are not limited to image display. For example, the electro-optical device may be applied to various lighting devices, such as an exposure apparatus (exposure head) that forms a latent image on an image carrier, such as a photoreceptor drum, by irradiating rays of light, a device (backlight) that is arranged in the back side of a liquid crystal display device to illuminate it, and a device that is installed in an image reader, such as a scanner, to illuminate a document or an image. Thus, it is possible to apply the electro-optical device to various applications.

### BRIEF DESCRIPTION OF THE DRAWINGS

The invention will be described with reference to the accompanying drawings, wherein like numbers reference like elements.

FIG. 1 is a block diagram of a configuration of an electro-optical device according to a first embodiment of the invention.

FIG. 2 is a block diagram showing a relation between each unit circuit and its peripheral circuit.

FIG. 3 is a timing chart showing waveforms of signals for driving the unit circuit.

FIG. 4 is a circuit diagram of a configuration of each unit circuit.

FIG. 5 is a timing chart showing waveforms of signals supplied to the unit circuit in an alternative embodiment.

FIG. 6 is a timing chart showing waveforms of signals supplied to the unit circuit in an alternative embodiment.

FIG. 7 is a block diagram showing a relation between each unit circuit and its peripheral circuit according to a second embodiment of the invention.

FIG. 8 is a timing chart showing waveforms of signals for driving the unit circuit.

FIG. 9 is a block diagram showing a relation between each unit circuit and its peripheral circuit according to a third embodiment of the invention.

FIG. 10 is a tiring chart illustrating the function of a regulator circuit.

FIG. 11 is a block diagram of a configuration of an electro-optical device according to a fourth embodiment of the invention.

FIG. 12 is a block diagram showing a relation between a configuration of each unit circuit and a gate driving circuit.

FIG. 13 is a timing chart illustrating the operation of the unit circuit.

FIG. 14 is a block diagram showing a relation between a configuration of a unit circuit according to a fifth embodiment of the invention and a gate driving circuit.

FIG. 15 is a timing chart illustrating the operation of the unit circuit.

FIG. 16 is a block diagram snowing a relation between a configuration of a unit circuit according to a sixth embodiment of the invention and a gate driving circuit.

FIG. 17 is a timing chart illustrating the function of a regulator circuit.

FIG. 18 is a block diagram showing a relation between a configuration of a unit circuit according to a seventh embodiment of the invention and a gate driving circuit.

FIG. 19 is a timing chart illustrating the operation of the unit circuit.

FIG. 20 is a circuit diagram of a partial configuration of each unit circuit according to an alternative embodiment.

FIG. 21 is a circuit diagram of a partial configuration of each unit circuit according to an alternative embodiment.

FIG. 22 is a perspective view of a first example embodiment of an electronic apparatus.

FIG. 23 is a perspective view of a second example embodiment of an electronic apparatus.

FIG. 24 is a perspective view o a third example embodiment of an electronic apparatus.

### DESCRIPTION OF EXEMPLARY EMBODIMENTS

### A: First Embodiment

### A-1: Configuration of Electro-optical Device

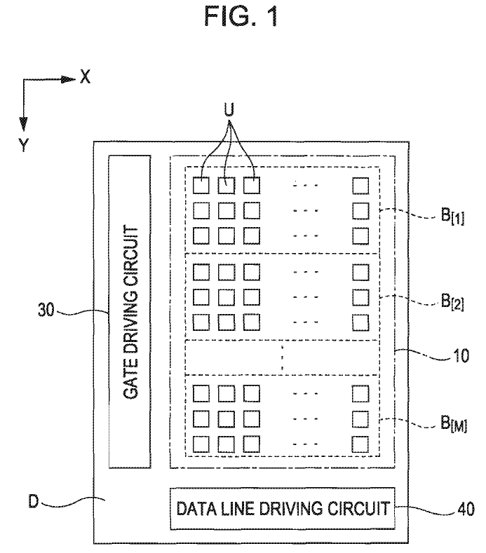

FIG. 1 is a block diagram of a configuration of an electro-optical device according to a first embodiment. The electro-optical device D is an image display device. The electro-optical device D includes an element array area 10, a gate driving circuit 30, and a data line driving circuit 40. A plurality of unit circuits (pixel circuits) U are arranged in the element array area 10. The gate driving circuit 30 drives the unit circuits U.

In the element array area 10, groups of n unit circuits U that are arranged in an X direction are arranged parallel to each other in a Y direction perpendicular to the X direction over m rows (n and m are natural numbers). That is, the plurality of unit circuits U are arranged in a matrix of horizontal m rows by vertical n columns. The unit circuits U are separated into M (M=m/3) groups B[1] to B[M], each including three successive rows of unit circuits U in the Y direction. That is, each group B[k] (k is an integer that satisfies 1≦k≦M) is a set of the unit circuits U that are arranged in horizontal three rows by vertical n columns.

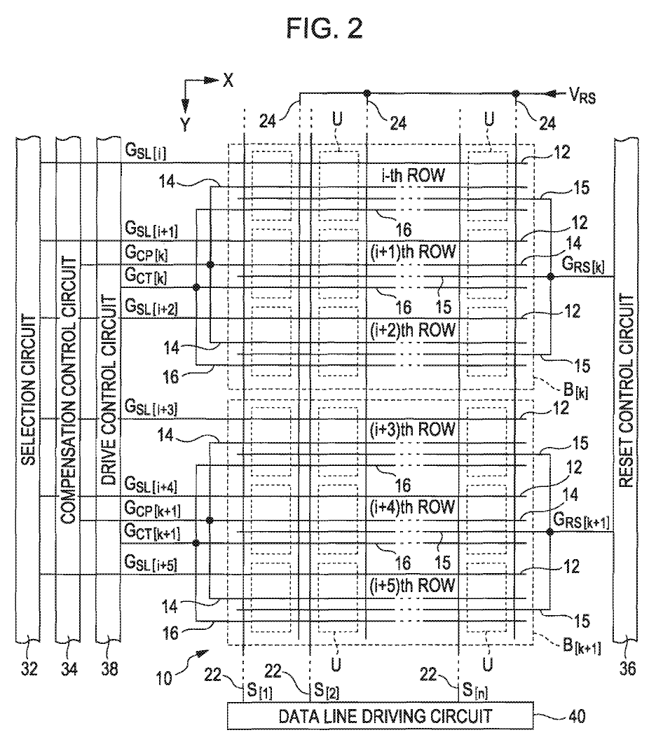

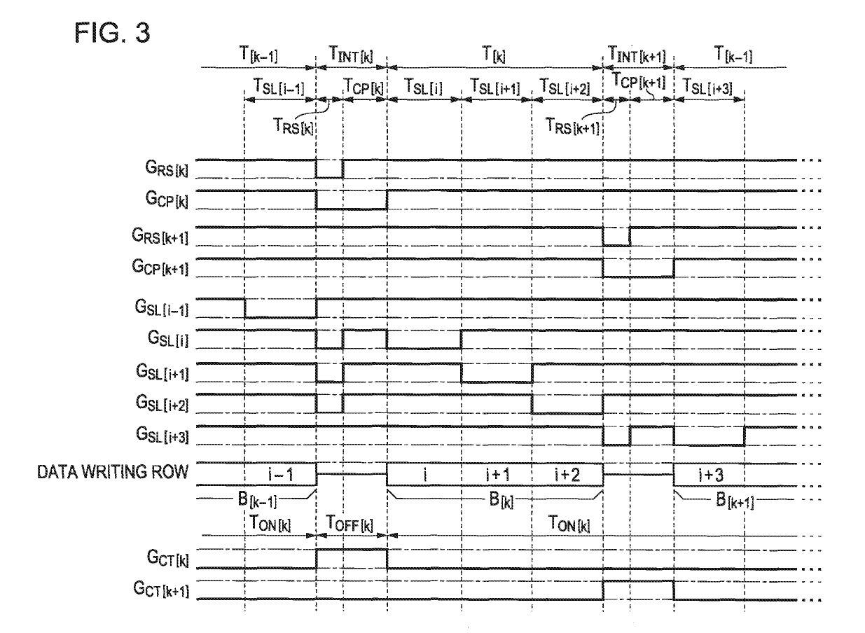

FIG. 2 is a block diagram showing a relation between each unit circuit U and the gate driving circuit 30. FIG. 3 is a timing chart showing waveforms of signals supplied to the unit circuits U. As shown in FIG. 2, m selection lines 12 that extend in the X direction and n data lines 22 that extend in the Y direction are formed in the element array area 10 (m and n are natural numbers). The unit circuits U are arranged at positions corresponding to intersections of the selection lines 12 and the data lines 22. In addition, control lines 14 to 16 that extend in the X direction in correspondence with each of the m selection lines 12 and power feed lines 24 that extend in the Y direction in correspondence with each of the n data lines 22 are formed in the element array area 10. Each of the power feed lines 24 is supplied with a predetermined electric potential (hereinafter, referred to as “reset potential”) VRS from a voltage generating circuit (not shown). Note that the power feed lines 24 may be formed to extend in the X direction.

Here, any one of the m selection lines 12 is connected to each of the n unit circuits U arranged in the X direction. Here, a group consisting of these n unit circuits U is an example of “unit circuit group”. Moreover, since any one of the m selection lines 12 is connected to the n unit circuits U that form the “unit circuit group”, it may be expressed that the “unit circuit group” is formed for each selection line 12.

As shown in FIG. 2, the gate driving circuit 30 includes a selection circuit 32, a compensation control circuit 34, a reset control circuit 36, and a drive control circuit 38. Note that, in FIG. 2, the reset control circuit 36 is illustrated to the right side of the element array area 10 for the purpose of convenience, but the positional relationship between the circuits that form the gate driving circuit 30 and the element array area 10 may be arbitrarily determined.

The selection circuit 32 is a device that sequentially selects each of the unit circuits U row by row by outputting selection signals GSL[1] to GSL[m] to the selection lines 12. For example, a shift register in which a plurality of multiple-stage flip-flops are connected may be preferably employed as the selection circuit 32. As shown in FIG. 3, the selection circuit 32 sequentially selects the i-th to (i+2)th rows that belong to a group B[k] during selection periods TSL[i] to TSL [i+2] within a group selection period T[k]. For example, the selection signal GSL[i] that is output to the i-th selection line 12 is changed to a low level (a level that specifies selection or that line) during the selection period TSL[i] included in the group selection period T[k]. As shown in FIG. 3, an initialization period TINT[k] is set between the group selection period T[k] and the preceding group selection period T[k−1]. The initialization period TINT[k] is a time length equivalent to that of one selection period TSL[i] (horizontal scanning period). The initialization period TINT[k] includes a reset period TRS[k] and a subsequent compensation period TCP[k]. The selection signals GSL[i] to GSL[i+2] corresponding to the group B[k], in addition to the respective selection periods TSL[i] to TSL[i+2], simultaneously attain low levels during the reset period TRS[k] of the initialization period TINT[k]. The selection signal GSL[i] maintains a high level during a period other than the reset period TRS[k] and the selection period TSL[i].

The compensation control circuit 34 shown in FIG. 2 is a device that generates M compensation control signals GCP[1] to GCP[M] corresponding to the groups B[1] to B[M] and outputs them to the corresponding control lines 14. Each of the 3n unit circuits U that belong to the group B[k] is supplied with the common compensation control signal GCP[k] through the three control lines 14 corresponding to the group B[k]. As shown in FIG. 3, the compensation control signal GCP[k] is changed to a low level (active level) during the initialization period TINT[k] and maintains a high level during the other period.

The reset control circuit 36 shown in FIG. 2 is a device that generates M reset control signals GRS[1] to GRS[M] and outputs them to the corresponding control lines 15. Each of the 3n unit circuits U that belong to the group B[k] is supplied with the common reset control signal GRS[k] through the three control lines 15 corresponding to the group B[k]. As shown in FIG. 3, the reset control signal GRS[k] is changed to a low level during the reset period TRS[k] and maintains a high level during the other period. As shown in FIG. 2, the compensation control circuit 34 and the reset control circuit 36 each are, for example, formed by a shift register in which a plurality of multiple-stage flip-flops are connected.

The drive control circuit 38 shown in FIG. 2 generates M drive control signals GCT[1] to GCT[M] and outputs them to the corresponding control lines 16. Each of the 3n unit circuits U that belong to the group B[k] is supplied with the common drive control signal GCT[k] through the three control lines 16 corresponding to the group B[k]. As shown in FIG. 3, the drive control signal GCT[k] maintains a low level during a driving period TON[k] and maintains a high level during a non-driving period TOFF[k]. A ratio of the time length (duty ratio) of the driving period TON[k] to the non-driving period TOFF[k] is variably controlled in accordance with external instructions. However, the non-driving period TOFF[k] is set to at least include the initialization period TINT[k] during which the compensation control signal GCP[k] is in a low level. The overall amount of light (brightness) in the element array area 10 is controlled in accordance with a ratio of the driving period TON[k] to the non-driving period TOFF[k].

The data line driving circuit 40 shown in FIG. 2 is a device that generates data signals S[1] to S[n] that specify gray-scale levels for the corresponding columns of unit circuits U and outputs them to the corresponding data lines 22. A data signal S[j], that is supplied to the j-th data line 22 during the selection period TSL[i] when the selection signal GSL[i] is in a low level, holds an electric potential VDATA corresponding to a gray-scale level specified by the i-th row and j-th column unit circuit U (electro-optical element E).

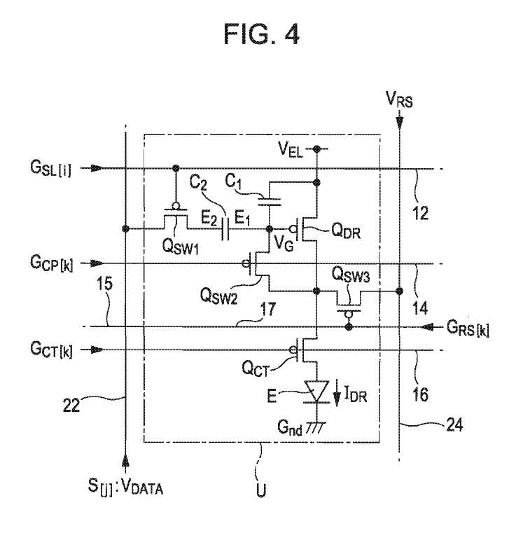

FIG. 4 is a circuit diagram showing a specific configuration of each unit circuit U. Note that only one unit circuit U arranged at the i-th row and j-th column, which belongs to the group B[k], is shown as an example, but other unit circuits U also have the same configurations.

As shown in FIG. 4, the unit circuit U includes an electro-optical element E. The electro-optical element E of the present embodiment is an organic light emitting diode element which includes an anode and, a cathode, which are opposed to each other, and a light emitting layer made of an organic EL (electroluminescence) material. The light emitting layer is held between the anode and the cathode. The electro-optical element E is arranged in a line that connects a power source line (high level side power source potential VEL) with a ground line (ground potential Gnd). The electro-optical element E emits light with the amount of light (luminous intensity) corresponding to the magnitude of electric current IDR (hereinafter, referred to as “driving current”) flowing in the line.

A p-channel driving transistor QDR is arranged in a line (between the power source line and the electro-optical element E) through which the driving current IDR flows. The source of the driving transistor QDR is connected to the power source line. The driving transistor QDR controls the magnitude of the driving current IDR in accordance with the potential of the gate (hereinafter, simply referred to as “gate potential”) VG of the driving transistor QDR. That is, the driving transistor QDR serves as a device that drives the electro-optical element E to emit the amount of light corresponding to the gate potential VG. A capacitive element C1 is connected between the gate and source (power source line) of the driving transistor QDR.

As shown in FIG. 4, the unit circuit U includes a capacitive element C2 that is constituted of an electrode E1 and an electrode E2. The electrode E1 is connected to the gate of the driving transistor QDR. A p-channel transistor QSW1 is connected between the electrode E2 and the data line 22 and controls electrical connection (conduction or non-conduction) therebetween. The gates of the transistors QSW1 of the n unit circuits U that belong to the i-th row are commonly connected to the i-th selection line 12.

A p-channel transistor QSW2 shown in FIG. 4 is a switching element that is connected between the gate and drain of the driving transistor QDR and controls electrical connection therebetween. The gate of the transistor QSW2 of each of the 3n unit circuits U that belong to the group B[k] is supplied with a common compensation control signal GCP[k] through the control line 14. When the transistor QSW2 is brought into a conductive state (on state), the gate and drain of the driving transistor QDR are electrically connected. This state is defined as a state where the driving transistor is diode-connected.

A transistor QSW3 is connected between the drain of the driving transistor QDR and the power feed line 24 and controls electrical connection therebetween. The gate of the transistor QSW3 of each of the 3n unit circuits U that belong to the group B[k] is supplied with a common reset control signal GRS[k] through the control line 15.

A p-channel drive control transistor QCT is connected between the drain of the driving transistor QDR and the anode of the electro-optical element E (that is, in a line that the driving current flows from the driving transistor QDR to the electro-optical element E). When the drive control transistor QCT is brought into a conductive state, the driving current IDR is supplied from the driving transistor QDR through the drive control transistor QCT to the electro-optical element E. Thus, the electro-optical element E emits light. In contrast, when the drive control transistor QCT is brought into a non-conductive state (off state), the line that the driving current IDR flows is interrupted and t-he electro-optical element E is turned off. That is, the drive control transistor QCT serves as a device that permits the driving transistor QDR to drive the electro-optical element E or that prohibits the driving transistor QDR from driving the electro-optical element E. The gate of the drive control transistor QCT of each of the 3n unit circuits U that belong to the group B[k] is supplied with a common drive control signal GCT[k] through the control line 16.

### A-2: Operation of Electro-Optical Device D

The operation of each unit circuit U will now be described focusing on the i-th to (i+2)th rows that belong to the group B[k]. As shown in FIG. 3, during the reset period TRS[k] within the initialization period TINT[k], both the compensation control signal GCP[k] and the reset control signal GRS[k] are changed to low levels. Thus, the transistor QSW2 is brought into a conductive state to diode-connect the driving transistor QDR, and the transistor QSW3 is brought into a conductive state to connect the drain of the driving transistor QDR to the power feed line 24. By so doing, the gate of the driving transistor QDR is electrically connected to the power feed line 24, so that the gate potential VG (the electric potential of the electrode E1) of each of the unit circuits U of the group B[k] is initialized to a reset potential VRS of the power feed line 24. In addition, during the reset period TRS[k], the data signal S[j] is set to a reference potential VREF. Furthermore, since the selection signals GSL[i] to GSL[i+2] are changed to low levels, the transistor QSW1 of each of the unit circuits U of the group B[k] is turned on. Hence, the electrode E2 of the capacitive element C2 is initialized to the reference potential VREF.

When the compensation period TCP[k] starts, the reset control signal GRS[k] is changed to a high level, so that each of the transistors QSW3 of the group B[k] is brought into a non-conductive state. On the other hand, since the compensation control signal GCP[k] continues to maintain a low level during the compensation period TCP[k], each of the transistors QSW2 of the group B[k] maintains a conductive state. Thus, the gate potential VG of the driving transistor QDR of each of the unit circuits U of the group B[k] converges on a differential value (VG→VEL−Vth) between the power source potential VEL supplied from the power source line and the threshold voltage Vth of the driving transistor QDR.

Incidentally, the gate potential VG may possibly fluctuate accidentally due to disturbance such as a noise. When the gate potential VG fluctuates to be an electric potential higher than “VEL−Vth” immediately before the compensation period TCP[k] starts, the gate potential VG does not converge on “VEL−Vth” within the compensation period TCP[k] and it is impossible to appropriately operate the unit circuit U. In contrast, according to the present embodiment, since the gate potential VG is forcibly set to have the reset potential VRS during the reset period TRS[K] before the compensation period TCP[k] starts, it is possible for the gate potential VG to reliably converge during the compensation period TCP[k]. As is understood from the foregoing description, the reset potential VRS is set to an electric potential lower than “VEL−Vth”.

When the initialization period TINT[k] has elapsed, the compensation control signal GCP[k] is changed to a high level. Thus, each of the transistors QSW2 of the group B[k] is brought into a non-conductive state to release diode-connection of the corresponding driving transistor QDR. Then, during the selection periods TSL[i] to TSL[i+2] that form the group selection period T[k], the transistors QSW1 of the unit circuits U that belong to the group B[k] are sequentially brought into on states row by row. During the selection period TSL[i], the data signal S[i] supplied to each of the data lines 22 is decreased to the electric potential VDATA.

Since the impedance of the gate of the driving transistor QDR is sufficiently high, the electric potential of the electrode E2 fluctuates from the reference potential VREF that is set during the reset period TRS[k] to the electric potential VDATA by the amount ΔV (ΔV=VREF−VDATA). Therefore, the electric potential of the electrode E1 fluctuates from the electric potential VG (=VEL−Vth) that is set during the initialization period TINT[k] due to capacitive coupling at the capacitive element C2. At this time, the amount of variation in electric potential of the electrode E1 is determined in accordance with a ratio of the capacitance of the capacitive element C2 to the capacitance generated around the capacitive element C2 For example, where the capacitance of the capacitive element CA is “cA”, the total capacitance that is associated with the gate of the driving transistor QDR, such as the capacitance of the capacitive element C1 and the capacitance of the gate of the driving transistor QDR is “cB”, the amount of variation in electric potential of the electrode E1 is expressed as “ΔVcA/(cA+cB)”. Thus, the gate potential VG of the driving transistor QDR is set to a level expressed by the following equation (1) during the selection period TSL[i].

### That is,

VG=VEL−Vth−kΔV (1)

### Where k=cA/(cA+cB)

### As described above, during the selection period TSL[i], the data signals S[1] to S[n] are written to the corresponding n unit Circuits U in the i-th row.

On the other hand, when the driving period TON[k] starts after the initialization period TINT[k] has elapsed, the drive control signal GCT[k] is changed to a low level. Therefore, the drive control transistors QCT of the corresponding 3n unit circuits U in the i-th to (i+2)th rows are simultaneously brought into on states. Thus, in each of the unit circuits U of the group B[k], the driving current IDR corresponding to the gate potential VG of the driving transistor QDR is supplied from the power source line through the driving transistor QDR and the drive control transistor QCT to the electro-optical element E. Thus, each of the electro-optical elements E emits light with the amount of light corresponding to the electric potential. VDATA of the data signal S[j].

Considering that the driving transistor QDR operates in a saturation region, the driving current IDR supplied to the electro-optical element E during the driving period TON[k] is expressed as the following equation (2). Where in equation (2), “β” is a coefficient of gain of the driving transistor QDR, “VGS” is a voltage between the gate and source of the driving transistor QDR.

$$\begin{matrix}IDR = ( β / 2 ) {( VGS - Vth )}^{2} \\ = ( β / 2 ) {( VEL - VG - Vth )}^{2}\end{matrix} \qquad ( 2 )$$

### Substituting equation (2) using equation (1), the following equation is obtained

IDR=(β/2)(k−ΔV)²

That is, the driving current IDR does not depend on the threshold voltage Vth of the driving transistor QDR. According to the present embodiment, is possible to suppress a difference (chrominance non-uniformity in gray-scale levels) in the amount of light of the electro-optical elements E due to variation in threshold voltages Vth of the driving transistors QDR (tolerance as compared to a designed value or a difference from the driving transistor QDR of other unit circuit U).

As described above, in the present embodiment, the transistors QSW2 of a plurality of rows, belonging to one group B[k], are controlled by the common compensation control signal GCP[k]. Thus, in comparison with the existing configuration in which a signal for controlling the transistor QSW2 is separately generated for each of m rows, the size of the compensation control circuit 34 is reduced. It is advantageous in that a power consumed in the compensation control circuit 34 is reduced owing to reduction in size of the circuit.

In the configuration in which a shift register that sequentially transmits a start pulse in synchronization with a clock signal is employed as the compensation control circuit 34, the capacitance (parasitic capacitance) associated with a wiring line for transmitting a clock signal is reduced by reducing the number of stages of flip-flops. Thus, a deformation in waveform of a clock signal due to the parasitic capacitance is suppressed and, as a result, it is advantageous in that malfunction of the compensation control circuit 34 may be prevented.

In addition, it is possible to reduce (the width of the window frame is reduced) the area of a region (a so-called window frame region) that needs to be ensured around the element array area 10 for arrangement of circuits by reducing the size of the compensation control circuit 34. Furthermore, the number of elements (for example, transistors) that form the compensation control circuit 34 is reduced, so that it is advantageous in that the yield of the compensation control circuit 34 is improved. Note that, when the compensation control circuit 34 is formed by active elements (for example, thin-film transistors whose semiconductor layers are formed of a low-temperature polysilicon) that are formed on the surface of the substrate together with the electro-optical elements E, the yield of the circuit tends to be reduced considerably in comparison with the case where the compensation control circuit 34 is mounted on the substrate in the form of an IC chip. Thus, since the present embodiment can improve the yield of the compensation control circuit 34, it is particularly preferable for the electro-optical device D which various elements are directly formed on the surface of the substrate,

In the present embodiment, the transistors QSW3 of a plurality of rows, belonging to one group B[k], are controlled by the common reset control signal GRS[k]. Thus, in comparison with the existing configuration in which a signal for controlling the transistor QSW3 is separately generated for each of m rows, the size of the reset control circuit 36 is reduced. Furthermore, since the drive control transistors QCT that belong to one group B[k] are controlled by the common drive control signal GCT[k], the size of the drive control circuit 38 is reduced. Thus, the above advantageous effects described for the compensation control circuit 34 are also obtained in the reset control circuit 36 and in the drive control circuit 38.

Note that, when the drive control transistor QCT is brought into a conductive state within the initialization period TINT[k], the gate potential VG is changed to an electric potential corresponding to electrical characteristics of the electro-optical element E, so that the gate potential VG is not set to “VEL−Vth” at the end of the compensation period TCP[k]. Thus, it is impossible to effectively compensate for variation in threshold voltages Vth of the driving transistors QDR. According to the present embodiment, since the drive control signal GCT[k] is generated so that the drive control transistor QCT is in an off state during the initialization period TINT[k], it is advantageous in that variation in threshold voltages Vth of the driving transistors QDR may be compensated in such a manner that the gate potential VG converges on “VEL−Vth” during the compensation period TCP[k].

### A-3: Alternative Embodiment of First Embodiment

The above exemplified embodiment may be modified into the following alternative embodiments.

### (1) First Alternative Embodiment

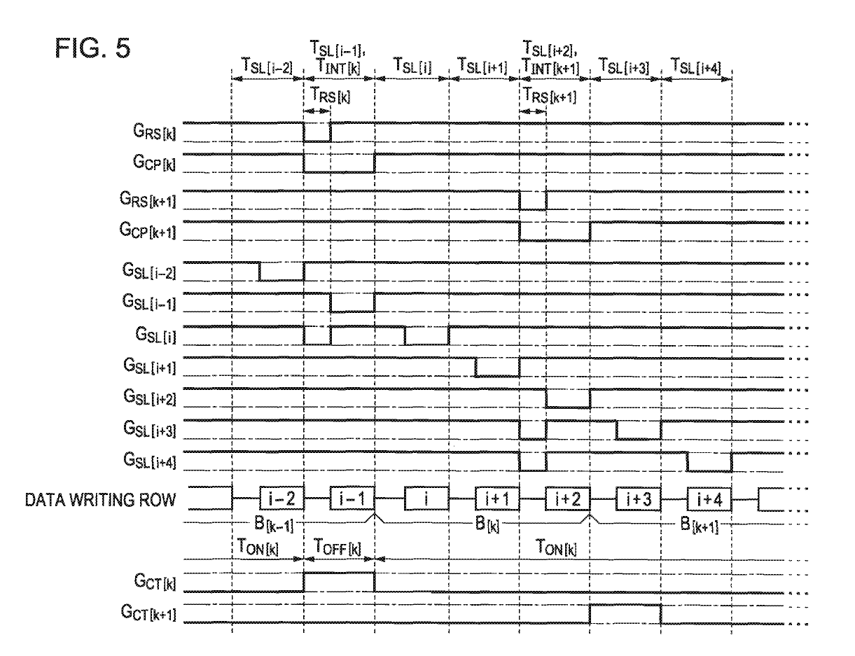

In the above described embodiment, as shown in FIG. 3, during the initialization period TINT[k], selection is not executed by the selection circuit 32 and writing of the data signals S[j] is not executed. However, writing of the data signals S[j] may be executed for each of the unit circuits U that belong to groups other than the group B[k] during the initialization period TINT[k]. For example, as shown in FIG. 5, it is applicable that selection of the (i−1)th row (that is, the row which will be selected for the last time in the group B[k−1]) that belongs to the group B[k−1] and writing of the data signals S[j] are executed within the initialization period TINT[k]. Note that, because the data signals S[j] are set to the reference potential VREF during the reset period TRS[k] within the initialization period TINT]k] the data signals S[j] cannot be written to the (i−1)th row unit circuits U. Thus, as shown in FIG. 5, the selection signal GSL[i−1] is in a low level (selection state) during a period other than the reset period TRS[k] within the initialization period TINT[k]. The same applies to the other selection signals. For example, the selection signal GSL[i] corresponding to one group B[k] is in a low level (selection state) during the reset period TRS[k] within the initialization period TINT[k] and a period of time that excludes that the time length corresponding to the time length of the reset period TRS[k] elapses from the start point within the selection period TEL[i].

In the configuration of the first embodiment, all the rows are not selected during the initialization period TINT[k]. Thus, the selection circuit 32 needs to include three flip-flops that output three selection signals GSL[i] to GSL[i+2] corresponding to the group B[k] and a flip-flop that delays a pulse by the amount of the initialization period TINT[k] for each of the groups B[1] to B[M]. That is, the selection circuit 32 of the first embodiment needs to include 4M flip-flops. In contrast, according to the configuration shown in FIG. 5, because it need not to bring all the rows into non-selection during the initialization period TINT[k], the selection circuit 32 only need to include m (3M) flip-flops. That is, according to the present embodiment, it is advantageous in that the size of the selection circuit 32 is reduced in comparison with the first embodiment.

### (2) Second Alternative Embodiment

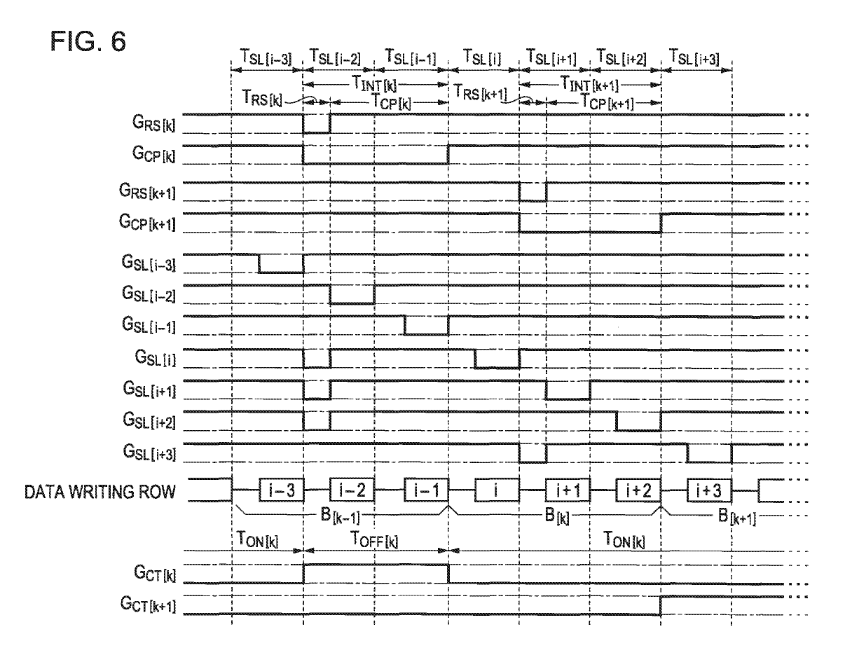

In the above described embodiment, the initialization period TINT[k] is set to have the same time length as the selection period TSL[i]. However, if the time length of the initialization period TINT[k] is not enough, the end point of the compensation period TCP[k] may come before the gate potential VG sufficiently converges on “VEL−Vth”. Then, as shown in FIG. 6, the compensation control signal GCP[k] may be set so that the initialization period TINT[k] corresponds to the time length of the plurality of selection periods TSL[i]. In the configuration shown in FIG. 6, as in the case of the configuration shown in FIG. 5, selection of rows (the (i−2)th row and the (i−1)th row) that belong to the group B[k−1] and writing of the data signals S[j] are executed during the initialization period TINT[k]. In addition, the time length of the non-driving period TOFF[k] specified by the drive control signal GCT[k] is set to the time length corresponding to the plurality of selection periods TSL[i] so as to include the initialization period TINT[k]. According to the above configurations it is possible to ensure the time length, that enables the gate potential VG to sufficiently converge, as the compensation period TCP[k].

### (3) Third Alternative Embodiment

In the above described embodiment, the compensation control signal GCP[k], the reset control signal GRS[k] and the drive control signal GCT[k] are supplied through the respective control lines 14, 15, 16 to the unit circuits U on a group B[k] to group B[k] basis. However, only the compensation control signal GCP[k] may be supplied through the control line 14 on a group B[k] to group B[k] basis, or only the reset control signal GRS[k] may be supplied through the control line 15 on a group B[k] to group B[k] basis. Furthermore, as will be described in a fourth embodiment, only the drive control signal GCT[k] may be supplied through the control line 16 on a group B[k] to group B[k] basis. Thus, any one of the control lines 14, 15, 16 may be shared (commonly connected) on a group B[k] to group B[k] basis. When any one of the control signals is supplied on a group B[k] to group B[k] basis, it is possible to simplify a driving circuit that supplies the control signals, so that it is advantageous in that the size of the circuit is reduced.

### B: Second Embodiment

The following will describe a second embodiment of the invention. Note that the same reference numerals are assigned to the components of the present embodiment having the same or similar operation and function as those of the first embodiment, and a detailed description thereof is omitted where appropriate.

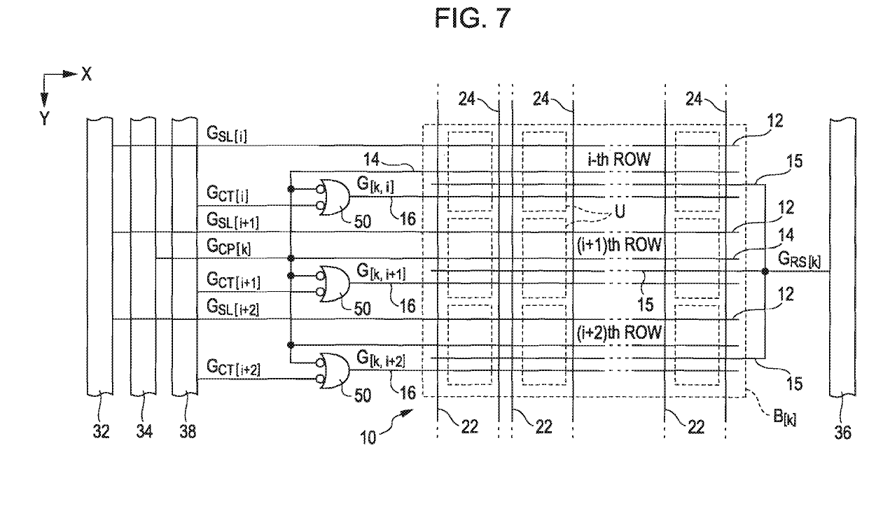

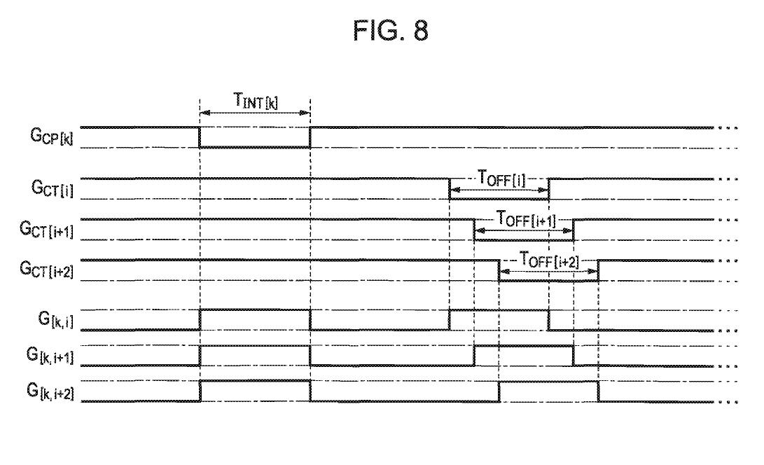

FIG. 7 is a block diagram showing a relation between each unit circuit IT and the gate driving circuit 30 according to the present embodiment. FIG. 8 is a timing chart showing waveforms of signals that are supplied to the unit circuits U. FIG. 7 shows only one group B[k] as an example.

As shown in FIG. 7 and FIG. 8, the drive control circuit 38 in the present embodiment generates drive control signals GCT[1] to GCT[m] for the corresponding m rows that form the element array area 10. The drive control signal GCT[i] is a signal that is in a low level during the non-selection period TOFF[i] when the start point is separately set on a row to row basis and that maintains a high level during the other period. The drive control signal GCT[i] is supplied to the gate of the drive control transistor QCT of each of the n unit circuits U in the i-th row through the i-th control line 16.

As shown in FIG. 7, m NAND circuits 50 corresponding to respective rows are arranged on the downstream side of the gate driving circuit 30. The NAND circuit 50 corresponding to the i-th row, belonging to the group B[k], is a logic circuit that generates and outputs a control signal G[k,i] corresponding to a non-conjunction of the compensation control signal GCP[k] that is generated by the compensation control circuit 34 and the drive control signal GCT[i] that is generated by the drive control circuit 38. The gates of the drive control transistors QCT of the unit circuits U that belong to the i-th row are commonly connected to the output terminal of the i-th NAND circuit 50. Thus, in the unit circuit shown in FIG. 4, the gate of the drive control transistor QCT is supplied not with the drive control signal GCT[i] but with the control signal G[k,i]. This control signal G[k,i] is an example of “logic signal”.

As shown in FIG. 8, the control signal G[k,i], which is a non-conjunction of the compensation control signal GCP[k] and the drive control signal GCT[i], maintains a high level during the non-driving period TOFF[i] that is specified by the drive control signal GCT[i] and, in addition, is in a high level during the initialization period TINT[k] when the compensation control signal GCP[k] is in a low level, irrespective of the level of the drive control signal GCT[i]. Because the drive control transistor QCT maintains a non-conductive state during a period when the control signal G[k,i] is in a high level, the supply of driving current IDR to the electro-optical element E (light emission) is interrupted during both the non-driving period TOFF[i] and the initialization period TINT[k].

As described above, according to the present embodiment, even when the non-driving period TOFF[i] of the drive control signal GCT[i] is set irrespective of the compensation control signal GCP[k], the drive control transistor QCT is reliably brought Into a non-conductive state during the initialization period TINT[k] (particularly, during the compensation period TCP[k]). That is, because it is unnecessary to have a configuration that associates the drive control signal GCT[i] with the compensation control signal GCP[k] so that the non-driving period TOFF[i] includes the initialization period TINT[k], according to the present embodiment, the size of the gate driving circuit 30 is further reduced as compared to that of the first embodiment For example, considering a configuration that a shift register that transmits and outputs a start pulse in synchronization with a clock signal is employed as the compensation control circuit 34 and/or the drive control circuit 38. According to the present embodiment, it is unnecessary to have a configuration that supplies a start pulse to both the compensation control circuit 34 and the drive control circuit 38 at the same timing. In addition, it is applicable that the clock signal that specifies the operation of the compensation control circuit 34 is different in periodic time and phase angle from the clock signal that specifies the operation of the drive control circuit 38.

### C: Third Embodiment

The following will describe a third embodiment of the invention. Note that the same reference numerals are assigned to the components of the present embodiment having the same or similar operation and function as those of the first embodiment or second embodiment, and a detailed description thereof is omitted where appropriate.

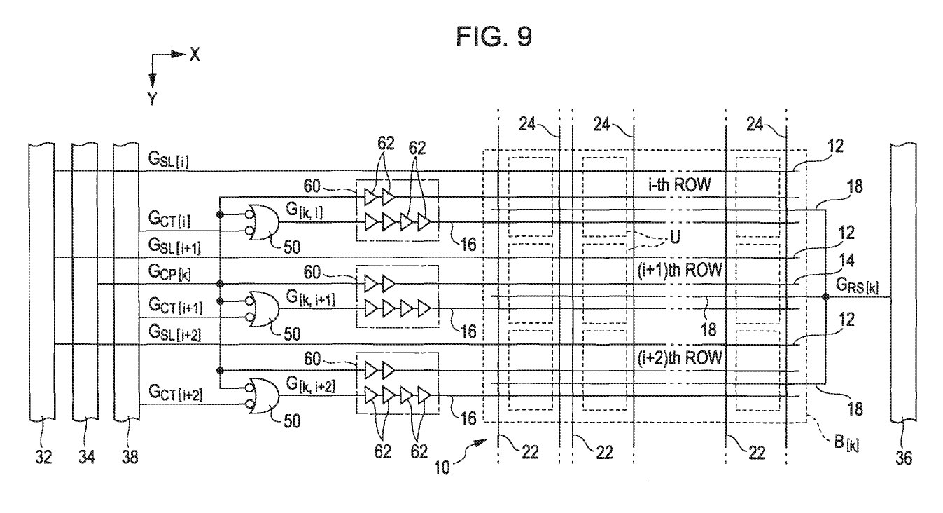

FIG. 9 is a block diagram showing a relation between each unit circuit U and the gate driving circuit 30 according to the present embodiment. As shown in FIG. 9, the electro-optical device D of the present embodiment includes m regulator circuits 60 corresponding to the respective rows in addition to the components of the second embodiment. The i-th regulator circuit 60 is a device that delays the control signal G[k,i] output from the i-th NAND circuit 50, that is, the logic signal, relative to the compensation control signal GCP[k]. The regulator circuit 60 of the present embodiment includes two buffers 62 that are arranged in a line through which the compensation control signal GCP[k] is supplied and four buffers 62 that are arranged in a line through which the control signal G[k,i] is supplied. Each of the buffers 62 that form the regulator circuit 60 serves as a delay element that delays a signal by a predetermined length of time.

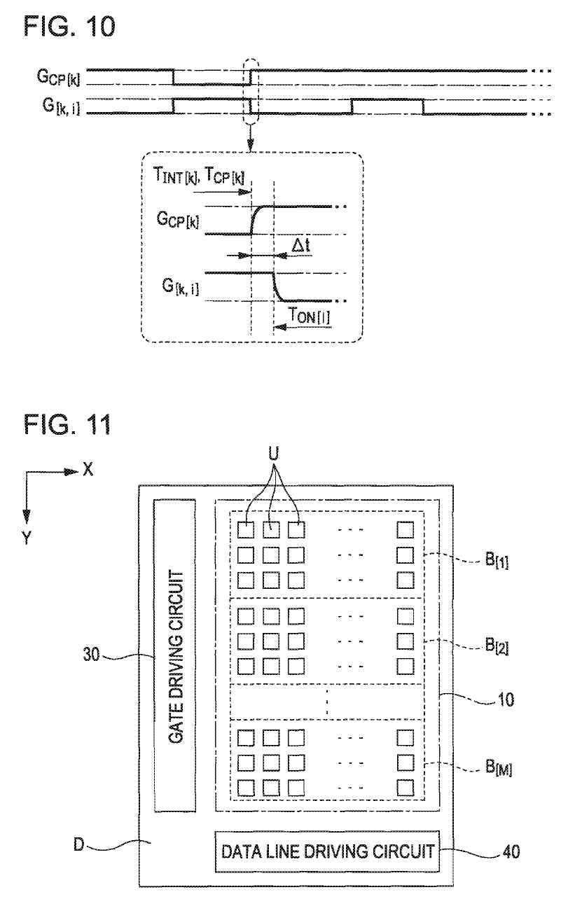

FIG. 10 is a timing chart showing a waveform of the compensation control signal GCP[k] and a waveform of the control signal G[k,i] according to the present embodiment. As shown in FIG. 9, the total number of buffers 62 (four buffers) that the control signal G[k,i] passes until it reaches the unit circuit U is greater than the total number of buffers 62 (two buffers) that the compensation control signal GCP[k] output from the compensation control circuit 34 passes. Thus, as shown in FIG. 10 in an enlarged view, the control signal G[k,i] is delayed by the time length Δt n comparison with the compensation control signal GCP[k].

If the compensation period TCP[k] overlaps the driving period TON[i] due to various situations such as a deformation in waveform of the compensation control signal GCP[k] and/or control signal G[k,i] (that is, if the transistor QSW2 and the drive control transistor QCT are simultaneously brought into conductive states), the gate potential VG does not become “VEL−Vth” at the start point of the selection period TSL[i]. For this reason, there may be a problem that the threshold voltage Vth of each driving transistor QDR is not compensated with high accuracy. In the present embodiment, because the control signal G[k,i] is delayed relative to the compensation control signal GCP[k], it is possible to start the driving period TON[i] after the initialization period TINT[k] has completely elapsed. Accordingly, it is possible to compensate for the threshold voltage Vth of each driving transistor QDR with high accuracy.

### D: Alternative Embodiments to First to Third Embodiments

The above described embodiments may be modified into various alternative embodiments. Specific alternative embodiments will be exemplified below. Note that the following embodiments may be combined with each other where appropriate.

### (1) First Alternative Embodiment

In the above described embodiments, as shown in FIG. 3, the driving period TON[k] continues from the start point of the selection period TSL[i] during which the i-th row is selected to the start point of the initialization period TINT[k] of the same row. However, the driving period TON[k] may be shortened where appropriate. In addition, the driving period TON[k] may be divided into a plurality of period with intervals between the adjacent periods (that is, the drive control transistor QCT may be intermittently brought into a conductive state). In the above described configuration, because the periodic time of switching of turning on/off of the electro-optical element E is shortened, flickering of image that a viewer recognizes is suppressed.

### (2) Second Alternative Embodiment

When the element array area 10 is separated into a plurality of groups B[1] to B[M], the number of rows in each group may be changed arbitrarily. For example, the element array area 10 may be separated into a plurality of groups B[1] to B[M] with two rows of unit circuits U or with four or more rows of unit circuits U. However, if the number of rows that belong to each group B[k] is large, it is necessary to sufficiently ensure the peak value of the compensation control signal GCP[K] and the peak value of the reset control signal GRS[k]. Thus, there will be a problem that a noise that is generated at the time when the level of the compensation control signal GCP[k] or the level of the reset control signal GRS[k] fluctuates becomes remarkably large and, as a result, it influences the operation of the electro-optical device D. Accordingly, it is desirable that the number of rows that belong to one group B[k] is equal to or less than 25% of the total number of rows in the element array area 10 (equal to or less than m/4 rows).

### (3) Third Alternative Embodiment

In the second embodiment, the operation of the electro-optical element E is prohibited during a period when the transistor QSW2 is in a conductive state. However, the operation of the electro-optical element E may be prohibited during a period when the transistor QSW3 is in a conductive state. For example, the i-th NAND circuit 50 outputs a non-conjunction of the reset control signal GRS[k] and the drive control signal GCT[i] as the control signal G[k,i]. The control signal G[k,i] in this configuration prohibits the operation of the electro-optical element E during the reset period TRS[k] when the transistor QSW3 is in a conductive state. Furthermore, the regulator circuit 60 of the third embodiment may be arranged. The i-th regulator circuit 60 delays the drive control signal GCT[i] relative to the reset control signal GRS[k].

### (4) Fourth Alternative Embodiment

The organic light emitting diode is one of examples of the electro-optical element. Regarding the electro-optical element, it need not to distinguish a selfluminous-type electro-optical element that emits light by itself from a nonluminous-type electro-optical element (for example, liquid crystal element) that changes its transmittance ratio of outside light and also need not to distinguish a current-drive-type electro-optical element that is driven by the supply of electric current from a voltage-drive-type electro-optical element that is driven by the application of voltage. For example, various electro-optical elements, such as an inorganic EL element, a field emission (FE) element, a surface-conduction electron-emitter (SE) element, a ballistic electron surface emitting (BS) element, a LED (light emitting diode) element, a liquid crystal element, an electrophoretic element and an electrochromic element, may be used.

### (5) Fifth Alternative Embodiment

In the above described embodiment, the drive control transistor QCT is connected between the driving transistor QDR and the electro-optical element E. However, the position of the drive control transistor QCT may be changed where appropriate. For example, as shown in FIG. 20, a configuration in which the drive control transistor QCT is connected between the gate of the driving transistor QDR and the power source line (or the source of the driving transistor QDR) is employed. During a period when the drive control transistor QCT maintains an off state (during the driving period TON[k]), the driving current IDR corresponding to the gate potential of the driving transistor QDR is supplied to the electro-optical element E. In contrast, during a period when the drive control transistor QCT maintains an on state (during the non-driving period TOFF[k]), the driving transistor QDR is in an off state (the voltage between the gate and the source becomes zero). For this reason, the supply of driving current IDR to the electro-optical element E is stopped. That is, the presence or absence of the supply of driving current IDR to the electro-optical element E changes in accordance with the state of the drive control transistor QCT (that is, the drive control signal GCT[k]).

In addition, as shown in FIG. 21, the configuration in Which the drive control transistor QCT is arranged in parallel with the electro-optical element E (the configuration in which the drive control transistor QCT is connected between the drain of the driving transistor QDR and the ground line) may be employed. During a period when the drive control transistor QCT maintains an off state (during the driving period TON[k]), the driving current IDR corresponding to the gate potential of the driving transistor QDR is supplied to the electro-optical element E. In contrast, during a period when the drive control transistor QCT maintains an on state (during the non-driving period TOFF[k]), the driving current IDR flows through the drive control transistor QCT to the ground line. For this reason, the supply of driving current IDR to the electro-optical element E is interrupted (or reduced) That is in the configuration shown in FIG. 21 as well, the supply of driving current IDR to the electro-optical element E is controlled in accordance with the state of the drive control transistor QCT.

As exemplified above, the drive control transistor QCT of one embodiment only needs to be a switching element that permits the electro-optical element E to operate or that prohibits the electro-optical element E from operating (typically, emission of light owing to the supply of driving current IDR), and its specific configuration and a relation with the other components (for example, the electro-optical element E or the driving transistor QDR) are arbitrary.

### E: Fourth Embodiment

FIG. 11 is a block diagram of a configuration of an electro-optical device according to a fourth embodiment. The electro-optical device D is a display device that displays an image. The electro-optical device D includes an element array area 10, a gate driving circuit 30 and a data line driving circuit 40. A plurality of unit circuits (pixel circuits) U are arranged in the element array area 10. The gate driving circuit 30 and the data line driving circuit 40 drive the unit circuits U.

In the element array area 10, groups of n unit circuits U that are arranged in an X direction are arranged parallel to each other in a Y direction perpendicular to the X direction over m rows (n and m are natural numbers). That is, the plurality of unit circuits U are arranged in a matrix of horizontal m rows by vertical n columns. The unit circuits U are separated into M (M=m/3) groups B[1” to B[M], each including three successive rows of unit circuits U in the Y direction. That is, each group B[k] (k is an integer that satisfies 1≦k≦M) is a set of the unit circuits U that are arranged in horizontal three rows by vertical n columns.

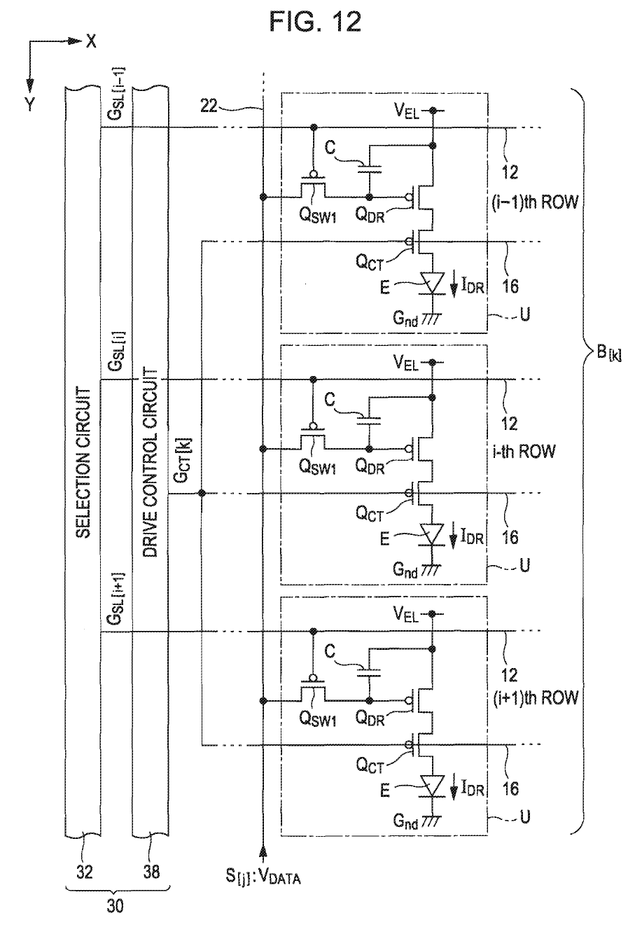

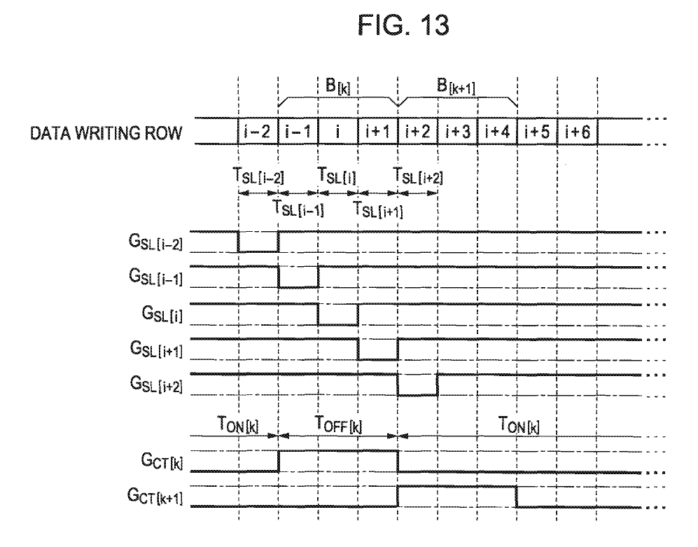

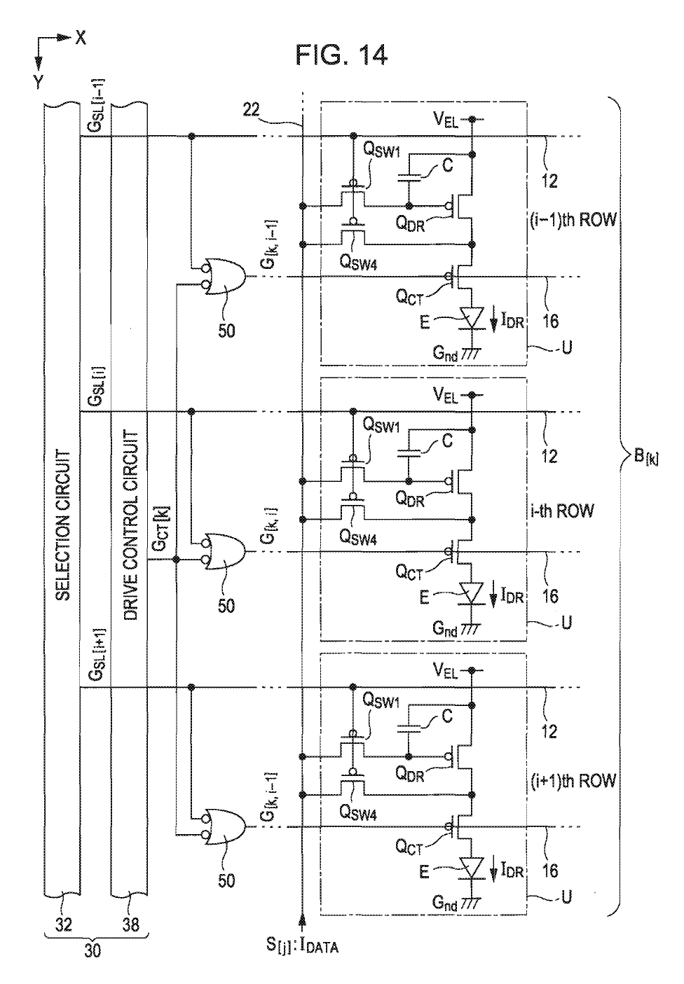

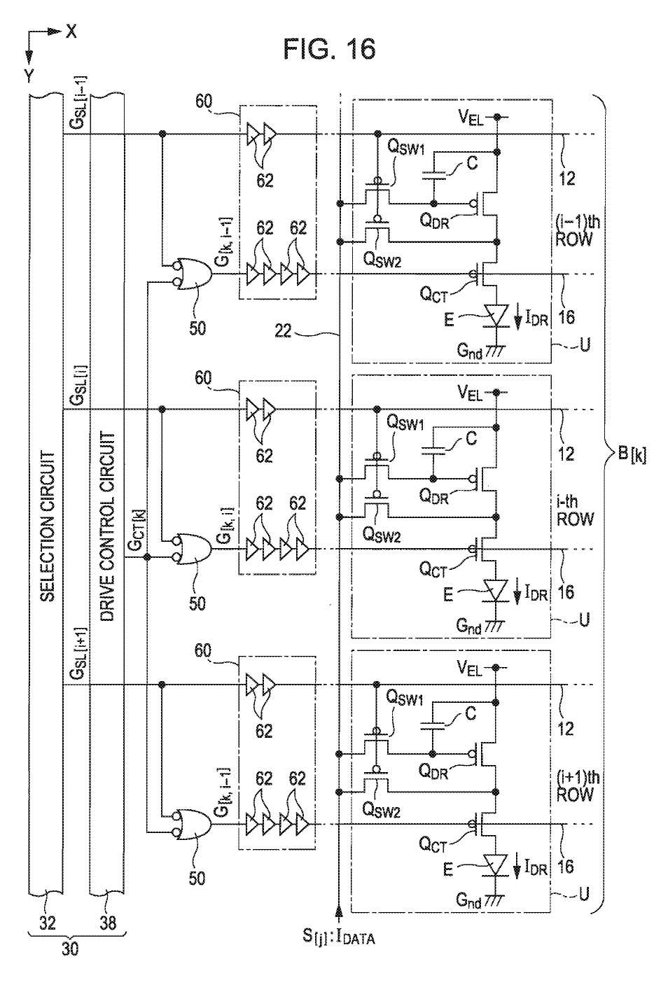

FIG. 12 is a block diagram showing a relation between a specific configuration of each unit circuit U and the gate driving circuit 30. FIG. 12 only shows three unit circuits U as an example, that belong to the j-th column (j is an integer that satisfies 1≦j≦n) within the group B[k] that includes the unit circuits of the (i−1)th to (i+1)ith rows (the same applies to FIG. 14 and FIG. 16; which will be shown later). In addition, FIG. 13 is a timing chart showing waveforms of signals that are supplied to the unit circuits U.

As shown in FIG. 12, m selection lines 12 that extend in the X direction and n data lines 22 that extend in the Y direction are formed in the element array area 10. Each of the unit circuits U is arranged at a position corresponding to an intersection of the selection line 12 and the data line 22. In addition, m control lines 16 that extend in the X direction in pairs with the selection lines 12 are formed in the element array area 10.

Here, any one of the m selection lines 12 is connected to the n unit circuits U that are arranged in the X direction. Here, a group consisting of these n unit circuits U is an example of “unit circuit group”. Moreover, since any one of the m selection lines 12 is connected to the n unit circuits U that form the “unit circuit group”, it may be expressed that the “unit circuit group” is formed for each selection line 12.

As shown in FIG. 12, the gate driving circuit 30 includes a selection circuit 32 and a drive control circuit 38. The selection circuit 32 is a device that sequentially selects each of the unit circuits U on a row to row basis. The selection circuit 32 of the present embodiment is a m-bit shift register that outputs the selection signals GSL[1] to GSL[m] to the respective selection lines 12. As shown in FIG. 13, the selection signals GSL[1] to GSL[m] are sequentially changed to an active level (a level that indicates selection of the row) during a predetermined length of period TSL[1] to TSL[m] that do not overlap each other (hereinafter, referred to as “selection period”). That is, the selection signal GSL[i] output to the i-th selection line 12 is changed to an active level (Low level) during the ith selection period TSL[i] within one frame period and maintains a high level (non-selection) during the other period.

The drive control circuit 38 shown in FIG. 12 is a device that generates and outputs M drive control signals GCT[1] to GCT[M] corresponding to the total number of groups B[1] to B[M]. For example, an M bit shift register may be preferably employed as the drive control circuit 38. As shown in FIG. 12, each of the 3n unit circuits U that belong to the group B[k] is supplied with a common drive control signal GCT[k] through three control lines 16 corresponding to the group B[k].

As shown in FIG. 13, the drive control signal GCT[k] maintains a low level during the driving period TON[k] and maintains a high level during the non-driving period TOFF[k]. A ratio of the time length (duty ratio) of the driving period TON[k] to the non-driving period TOFF[k] is variably controlled in accordance with external instructions. However, the non-driving period TOFF[k] may be changed in a range that at least includes selection periods TSL[i−1] to TSL[i+1] during which the selection circuit 32 selects the corresponding unit circuits U of the group B[k] (that is, the time length corresponding to the selection period TSL[i−1] to TSL[i+1] is defined as a shortest value) where appropriate. T-he overall amount of light (brightness) in the element array area 10 is controlled in accordance with the length of time of the driving period TON[k].

The data line driving circuit 40 shown in FIG. 11 is a device (for example, n voltage output-type D/A converter) that generates data signals S[1] to S[n] that specify gray-scale levels for the corresponding unit circuits U and outputs them to the corresponding data lines 22. The data signal S[j], that is supplied to the j-th data line 22 during the selection period TSL[i] when the selection signal GSL[i] is in a low level, becomes an electric potential VDATA corresponding to a gray-scale level that is specified for the i-th row and j-th column unit circuit U (electro-optical element E).

As shown in FIG. 12, each of the unit circuits U includes an electro-optical element E. The electro-optical element E of the present embodiment is an organic light emitting diode element which includes an anode and a cathode, which are opposed to each other, and a light emitting layer made of an organic EL electroluminescence) material. The light emitting layer is held between the anode and the cathode. The electro-optical element E is arranged in a line that connects a power source line high level side power source potential VEL) with a ground line (ground potential Gnd). The electro-optical element E emits light with the amount of light (luminous intensity) corresponding to the magnitude of electric current IDR (hereinafter, referred to as “driving current”) flowing in the line.

A p-channel driving transistor QDR is arranged in a line (between the power source line and the electro-optical element E) through which the driving current IDR flows. The driving transistor QDR is a device that controls the magnitude of driving current IDR (the amount of light emitted from the electro-optical element E) in accordance with the gate potential VG. A capacitive element C is connected between the gate and source (power source line) of the driving transistor QDR. In addition, a p-channel transistor QSW1 is connected between the gate of the driving transistor QDR and the data line 22 and controls electrical connection (conduction or non-conduction) therebetween, the gates of the transistors QSW1 of the i-th row unit circuits U are commonly connected to the i-th selection line 12.

A p-channel drive control transistor QCT is connected between the drain of the driving transistor QDR and the anode of the electro-optical element E (that is, in a line through which the driving current IDR flows from the driving transistor QDR to the electro-optical element E). The drive control transistor QCT is a switching element that controls electrical connection between the electro-optical element E and the driving transistor QDR. The gate of the drive control transistor QCT of each of the 3n unit circuits that belong to one group B[k] is supplied with a common drive control signal GCT[k] through the three control lines 16 corresponding to the group B[k].

In the above described configuration, for example, when the selection signal GSL[i] is changed to a low level during the selection period TSL[i], the i-th row transistors QSW1 are simultaneously brought into on states. Thus, in the i-th row and j-th column unit circuit U, the gate of the driving transistor QDR is supplied with an electric potential VDATA of the data signal S[j], and an electric charge corresponding to the electric potential VDATA is stored in the capacitive element C. That is, as shown in FIG. 13, during the selection period TSL[i], the data signals S[1] to S[n] are written to the corresponding i-th row n unit circuits U.

On the other hand, since the drive control signal GCT[k] maintains a high level during the non-driving period TOFF[k] that includes selection periods TSL[i−1] to TSL[i+1], the drive control transistor QCT is brought into an off state to interrupt the driving current IDR. As a result, the electro-optical element E turns off a light.

Because the selection signal GSL[i] is changed to a high level after the selection period TSL[i] has elapsed, the i-th row transistors QSW1 are brought into off states. The gate of the driving transistor QDR is maintained at an electric potential VDATA of the data signal S[j] by the capacitive element C after the selection period TSL[i] has elapsed (during the driving period TON[k]).

On the other hand, when the driving period TON[k] starts after the selection periods TSL[i−1] to TSL[i+1] have elapsed, the drive control signal GCT[k] is changed to a low level. For this reason, the drive control transistors QCT of the 3n unit circuits of the (i−1)th to (i+1)th rows are simultaneously brought into on states. Thus, in each of the unit circuits U of the group B[k], the driving current IDR having a magnitude corresponding to the data signal S[j] that is supplied during the preceding selection period TSL[i−1] to TSL[i+1] is supplied from the power source line through the driving transistor QDR and the drive control transistor QCT to the electro-optical element E. The electro-optical element E emits light with the amount of light corresponding to the driving current IDR.

As described above, in the present embodiment, the plurality of rows of drive control transistors QCT that belong to one group B[k] are controlled by one drive control signal GCT[k]. Thus, in comparison with the existing configuration in which a signal for controlling the drive control transistor QCT is separately generated for each of m rows, the size of the drive control circuit 38 is reduced. For example, according to the present embodiment in which the element array area 10 is separated into M groups B[1] to B[M] in units of three rows, the number of stages of flip-flops that form the drive control circuit 38 is reduced to approximately one thirds. It is advantageous in that a power consumed in the drive control circuit 38 is reduced owing to reduction in size of the circuit.

In the configuration in which a shift register that sequentially transmits and outputs a start pulse in synchronization with a clock signal is employed as the drive control circuit 38, the capacitance (parasitic capacitance) associated with a wiring line for transmitting a clock signal is reduced by reducing the number of stages of flip-flops. Thus, a deformation in waveform of a clock signal due to the parasitic capacitance is suppressed and, as a result, it is advantageous in that malfunction of the drive control circuit 38 may be prevented.

In addition, it is possible to reduce (the width of the window frame is reduced) the area of a region (a so-called window frame region) that needs to be ensured around the element array area 10 for arrangement of circuits by reducing the size of the drive control circuit 38. Furthermore, the number of elements (for example, transistors) that form the drive control circuit 38 is reduced, so that it is advantageous in that the yield of the drive control circuit 38 is improved. Mote that, when the drive control circuit 38 is formed by active elements (for example, thin-film transistors whose semiconductor layers are formed of a low-temperature polysilicon) that are formed on the surface of the substrate together with the electro-optical elements E, the yield of the circuit tends to be reduced considerably in comparison with the case where the drive control circuit 38 is mounted on the substrate in the form of an IC chip. Thus, since the present embodiment can improve the yield of the drive control circuit 38, it is particularly preferable for the electro-optical device D which various elements are directly formed on the surface of the substrate.

driving period TON[k] during which the electro-optical element E is driven is specified by the drive control signal GCT[k], so that, for example, the gray-scale level (the amount of light emitted) of each electro-optical element E when the same gray-scale level is specified for each of the electro-optical element E is controlled on a group B[k] to group B[k] basis. Thus, for example, if the numbers of rows that belong to the respective groups B[1] to B[M] are different, a viewer may recognize that the gray-scale levels are not uniform over the entire element array area 10. In the present embodiment, because each of the groups B[1] to B[M] includes the same number (3n) of unit circuits U, it is advantageous in that the gray-scale levels are uniform over the entire element array area 10.

Since the non-driving period TOFF[k] is set to a period that at least includes the selection periods TSL[4i−1] to TSL[i+1], the drive control transistor QCT is in an off state when the electric potential VDATA of the data signal S[j] is supplied to each of the unit circuits U of the group B[k]. That is, in the present embodiment, the operation (light emission) of the electro-optical element E is permitted after writing of the data signal S[j] to each of the unit circuits U is completed Accordingly, for example, in comparison with the configuration in which driving of the electro-optical element E is initiated in the selection periods TSL[i−1] to TSL[i+1] (that is, the drive control signal GCT[k] is changed to a low level), it is possible to control the gray-scale level of each electro-optical element E with high accuracy.

### F: Fifth Embodiment

The following will describe a fifth embodiment of the invention. Note that the same reference numerals are assigned to the components of the present embodiment having the same or similar operation and function as those of the fourth embodiment, and a detailed description thereof is omitted where appropriate.

FIG. 14 is a block diagram showing a relation between a specific configuration of each unit circuit U and the gate driving circuit 30 according to the present embodiment. FIG. 12 illustrates a voltage-programming-type unit circuit U in which the gray-scale level of the electro-optical element E is set in accordance with the electric potential VDATA of the data line 22. The unit circuit U illustrated in FIG. 14 employs a current-programing-type in which the gray-scale level of the electro-optical element E is set in accordance with an electric current that flows in the data line 22.

As show in FIG. 14, each of the unit circuits U includes a transistor QSW4 in addition to the components of the first embodiment. The transistor QSW4 is a switching element that is connected between the drain of the driving transistor QDR and the data line 22 and controls electrical connection therebetween. In addition, the data line driving Circuit 40 outputs the data signal S[j] of an electric current VDATA corresponding to a gray-scale level specified by the i-th row and j-th column unit circuit U during the selection period TSL[i] when the selection signal GSL[i] is in a low level.

As shown in FIG. 14, m NAND circuits 50 corresponding to respective rows are arranged on the downstream side of the gate driving circuit 30. The NAND circuit 50 corresponding to the i-th row that belongs to the group B[k] is a logic circuit that generates and outputs a control signal G[k,i] corresponding to a non-conjunction of the selection signal GSL[i] and the drive control signal GCT[i]. The gates of the drive control transistors QCT of the unit circuits U that belong to the i-th row are commonly connected to the output terminal of the i-th NAND circuit 50. Thus, in the present embodiment, in the unit circuit shown in FIG. 14, the gate of the drive control transistor QCT is supplied not with the drive control signal GCT[k] but with the control signal G[k,i]. This control signal G[k,i] is an example of “logic signal”.

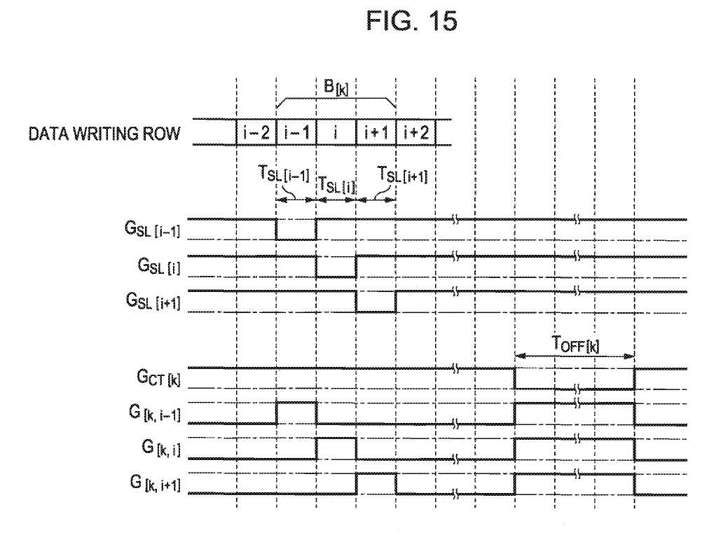

FIG. 15 is a timing chart illustrating the operation of the unit circuit U according to the present embodiment. As shown in FIG. 15, the selection circuit 32 generates the selection signal GSL[1] to GSL[m] that have the same waveforms as those of the first embodiment. The drive control signal GCT[k] that the drive control circuit 38 generates for the group B[k] is changed to a low level during the non-driving period TOFF[k] and maintains a high level during the other period. The drive control circuit 38 variably controls the time length of the non-driving period TOFF[k] in accordance with external instructions.

As shown in FIG. 15, the control signal G[k,i], which is a non-conjunction of the selection signal GSL[i] and the drive control signal GCT[k], maintains a high level during the non-driving period TOFF[k] and, in addition, is in a high level during the selection period TSL[i] when the selection signal GSL[i] is in a low level, irrespective of the level of the drive control signal GCT[k]. Because the drive control transistor QCT maintains an off state during a period when the control signal G[k,i] is in a high level, the supply of driving current IDR to the electro-optical element E (light emission) is interrupted during the selection period TSL[i] when the data signal S[j] is written to one unit circuit U.

According to the present embodiment, even when the non-driving period TOFF[k] of the drive control signal GCT[k] is set irrespective of (asynchronously with) the selection signal GSL[i] as illustrated in FIG. 15, it is possible to control a gray-scale level with high accuracy by interrupting driving of the electro-optical element E within the selection period TSL[i]. That is, because it is unnecessary to have a configuration that associates the drive control signal GCT[k] with the writing signals GST[i−1] to GSL[i+1] so that the non-driving period TOFF[k] includes the selection periods TSL[i−1] to TSL[i+1], according to the present embodiment, it is advantageous in that the size of the gate driving circuit 30 is further reduced as compared to that of the first embodiment. For example, considering a configuration that a shift register that transmits and outputs a start pulse in synchronization with a clock signal is employed as the selection circuit 32 and/or the drive control circuit 38, according to the present embodiment, it is unnecessary to have a configuration that supplies a start pulse to both the selection circuit 32 and the drive control circuit 38 at the same timing. In addition, it is applicable that the clock signal that specifies the operation of the selection circuit 32 is different in periodic time and timing from the clock signal that specifies the operation of the drive control circuit 33.

The following will describe the operation of the unit circuit U. As shown in FIG, 15, when the selection signal GSL[i] Is changed to a low level during the selection period TSL[i], the transistors QSW1 and QSW4 both are brought into on states, so that the gate and drain of the driving transistor QDR are electrically connected (diode-connected). Thus, the electric current IDATA of the data signal S[j] that is controlled by the data line driving circuit 40 flows from the power source line through the driving transistor QDR and the transistor QSW2 to the j-th data line 22. As a result, an electric charge corresponding to the electric current IDATA is stored in the capacitive element C. On the other hand, during the selection period TSL[i], the control signal G[k,i] maintains a high level, so that the drive control transistor QCT is brought into an off state. Hence, the i-th low electro-optical elements E turn off a light.

Subsequently, when the selection signal GSL[i] is changed to a high level after the selection period TSL[i] has elapsed, both the transistor QSW1 and the transistor QSW2 are brought into off states. Thus, the gate potential of the driving transistor QDR is maintained at a voltage that has been set by the capacitive element C immediately before the selection period TSL[i]. In the above situation, when the control signal G[k,i] is changed to a low level and the drive control transistor QCT is then brought into an on state, the driving current IDR corresponding to the electric charge held by the capacitive element C is supplied through the drive control transistor QCT to the electro-optical element E. Accordingly, the electro-optical element E emits light with the amount of light corresponding to the electric current IDATA that flows in the data signal S[j].

### G: Sixth Embodiment

The following will describe a sixth embodiment of the invention. Note that the same reference numerals used in FIG. 11 and FIG. 12 are assigned to the components of the present embodiment having the same or similar operation and function as those of the fourth embodiment, and a detailed description thereof is omitted where appropriate.

FIG. 16 is a block diagram showing a relation between a specific configuration of each unit circuit U and the gate driving circuit 30 according to the present embodiment. As shown in FIG. 16, the electro-optical device D of the present embodiment includes m regulator circuits 60 corresponding to the respective rows in addition to the components of the fifth embodiment. The i-th regulator circuit 60 is a device that delays the control signal G[k,i] output from the i-th NAND circuit 50, that is, the logic signal, relative to the selection signal GSL[i]. The regulator circuit 60 of the present embodiment includes two buffers 62 that are arranged in a line through which the selection signal GSL[i] is supplied and four buffers 62 that are arranged in a line through which the control signal G[k,i] is supplied. Each of the buffers 62 that form the regulator circuit 60 serves as a delay element that delays a signal by a predetermined length of time.

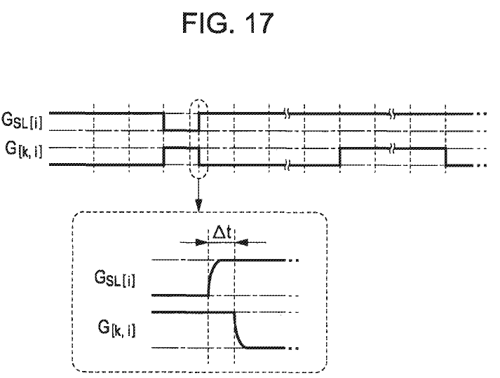

FIG. 17 is a timing chart showing a waveform of the selection signal GSL[i] and a waveform of the control signal G[k,i] according to the present embodiment. As shown in FIG. 16, the total number of buffers 62 (four buffers) that the control signal G[k,i] passes until it reaches the unit circuit U is greater than the total number of buffers 62 (two buffers) that the selection signal GSL[i] passes. Thus, as shown in FIG. 17 in an enlarged view, the control signal G[k,i] is delayed by the time length Δt in comparison with the selection signal GSL[i].

If the selection period TSL[i] overlaps the driving period TON[i] due to various situations such as a deformation in waveform of the selection signal GSL[i] and/or drive control signal GCT[k] (that is, if the electro-optical element E initiates to emit light in the middle of the selection period TSL[i]), there may be a case that the amount of light emitted from the electro-optical element E does not coincide with a desired value. In the present embodiment, because the control signal G[k,i] is delayed relative to the selection signal GSL[i], it is possible to start the driving period TON[k] after the selection period TSL[i] has completely elapsed. Accordingly, it is possible to reliably prevent malfunction that the electro-optical element E initiates to emit light in the middle of the selection period TSL[i].

### H: Seventh Embodiment

The drive control circuit 38 according to the above embodiments may be employed for an electro-optical device D (light receiving device) that generates an electrical signal corresponding to the amount of light that the electro-optical device D receives outside light, such as sunlight or illumination light. Note that the same reference numerals used in FIG. 11 and FIG. 12 are assigned to the components of the present embodiment having the same or similar operation and function as those of the fourth embodiment, and a detailed description thereof is omitted where appropriate.

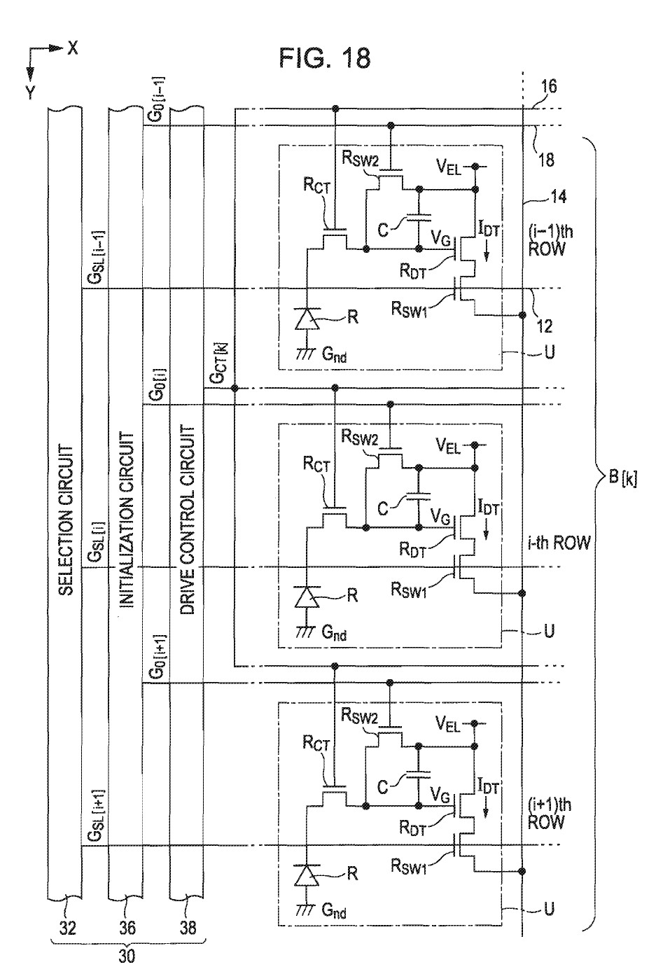

FIG. 18 is a block diagram of a configuration of an electro-optical device D according to the present embodiment. Note that the electro-optical device D includes unit circuits U that are arranged in a matrix of horizontal m rows by vertical n columns as in the case of the above embodiments. However, FIG. 18 shows the unit circuits U of the j-th column in the (i−1)th to (i+1)th rows that belong to one group B[k] for the purpose of convenience. Each of the unit circuits U includes an electro-optical element (light receiving element) R, such as a photodiode that changes its electrical characteristics (resistance) in accordance with the amount of light received.

As shown in FIG. 18, the unit circuit U includes a detecting transistor RDT that generates an electric current (hereinafter, referred to as “detection current”) IDT in accordance with the gate potential VG. The detecting transistor RDT is an n-channel transistor that s connected between the Dower source line and the data line 22. An n-channel drive control transistor RCT is connected between the gate of the detecting transistor RDT and the electro-optical element R and controls electrical connection therebetween.

The drive control circuit 38 outputs M drive control signals GCT[1] to GCT[M] corresponding to the respective groups B[1] to B[M]. The gate of the drive control transistor RCT of each of the 3n unit circuits U that belong to the group B[k] is supplied with a common drive control signal GCT[k] through three control lines 16 corresponding to the group B[k].

An n-channel transistor RSW1 is connected between the detecting transistor RDT and the data line 22 and controls electrical connection therebetween. The gate of the transistor RSW1 of each of the i-th row unit circuits U is supplied with the selection signal GSL[i] from the selection circuit 32. In addition, a capacitive element C and an n-channel transistor RSW2 are connected in parallel with each other between the gate of the detecting transistor RDT and the power source line (the drain of the detecting transistor RDT). The gate of the transistor RSW2 is connected to an initialization line 18. The initialization line 18 is supplied with the initialization signal G0[i] from the initialization circuit 36.

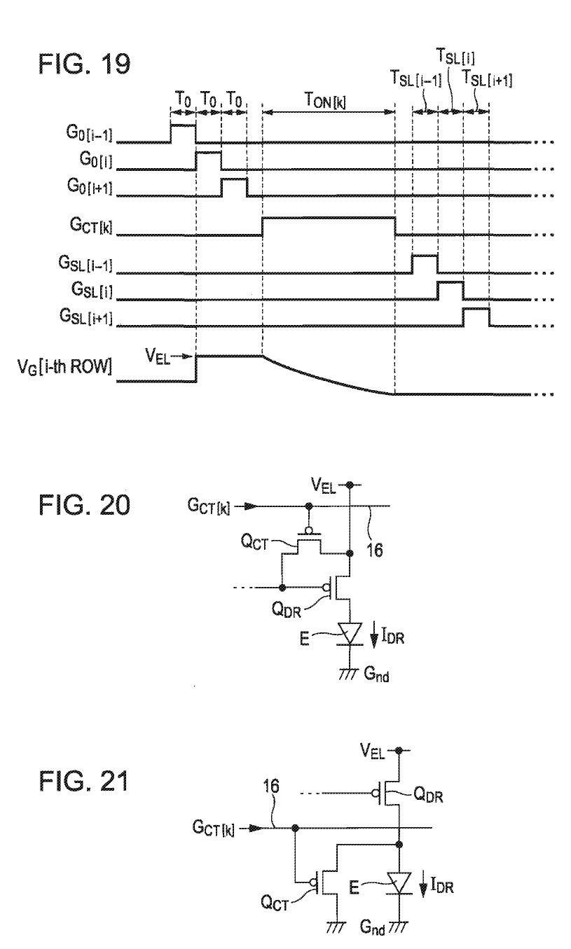

FIG. 19 is a timing chart illustrating the operation of the electro-optical device D. As shown in FIG. 19, the selection signals GSL[1] to GSL[m] output from the selection circuit 32 sequentially attain active levels (high levels) during the corresponding selection periods TSL[1] to TSL[m] as in the case of the fourth embodiment. The drive control signal GCT[k] is changed to an active level. (high level) during the driving period TON[k] that comes before the selection of the (i−1)th to (i+1)th rows that belong to the group B[k] and maintains a low level during the other period In addition, the initialization signals G0[1] to G0[m] sequentially attain high levels before the driving period TON[k] starts.

In the above described configuration, when the initialization signal G0[i] is changed to a high level, the transistor RSW2 is brought into an on state in each of the i-th row unit circuits U. Thus, as shown in FIG. 19, the gate potential VG of the detecting transistor RDT is initialized to a power source potential VEL.

When the gate potential VG is initialized in each of the unit circuits U that belong to one group B[k], the drive control signal GCT[k] is changed to a high level during the driving period TON[k], so that the drive control transistors RCT of the group B[k] are brought into on states. In this manner, because the electro-optical element R is supplied with an electric current corresponding to the amount of light received, the gate potential VG of the detecting transistor RDT, as shown in FIG. 19, gradually decreases at a rate corresponding to the amount of light received by the electro-optical element R from the power source potential VEL immediately after the initialization. At the time when the drive control signal GCT[k] is changed to a low level (at the end point of the driving period TON[k]), the gate potential VG is maintained by the capacitive element C. Thus, the gate potential VG at the end point of the driving period TON[k] is determined in accordance with the amount of light received by the electro-optical element R.

When the selection signal GSL[i] is changed to a high level and the transistor RSW1 is brought into an on state, the magnitude of detection current IDT corresponding to the gate potential VG that has been set during the preceding driving period TON[k] flows through the detecting transistor RDT and the transistor RSW1 to the data line 22. That is, the detection current IDT corresponding to the amount of light received by the electro-optical element R of each row is output to the data line 22 during each of the selection periods TSL[1] to TSL[m] in a timesharing manner. The data line driving circuit 40 outputs, to the outside, data corresponding to a value of the detection current IDT that flows in the data line 22. The Amount of light received by each of the electro-optical elements R is detected by means of analysis of data output from the data line driving circuit 40.

As described above, in the present embodiment, the plurality of rows of drive control transistors RCT that belong to one group B[k] are controlled by one drive control signal GCT[k]. Thus, as in the case of the fourth embodiment, in comparison with the existing configuration in which a signal for controlling the drive control transistor RCT is separately generated for each of m rows, it is advantageous in that the size of the drive control circuit 38 is reduced. Note that the above embodiment illustrates a configuration that the unit circuit U of the fourth embodiment is modified for light receiving use; however, the NAND circuit 50 of the fifth embodiment and/or the regulator circuit 60 of the sixth embodiment may be added to the configuration shown in FIG. 18.

### I: Alternative Embodiments to Fourth to Seventh Embodiments

The above described embodiments may be modified into the following alternative embodiments. Specific alternative embodiments will be exemplified below. Note that the following embodiments may be combined with each other where appropriate.

### (1) First Alternative Embodiment

In the above described embodiments, the driving period TON[k] continues within an interval between the adjacent selection periods TSL[i]. However, the driving period TON[k] may be divided into a plurality of periods with intervals between the adjacent periods. The drive control transistor QCT in this configuration is intermittently brought into an on state within a period of interval between the adjacent selection periods TSL[i]. According to this configuration, because the periodic time of switching between the driving period TON[k] and the non-driving period TOFF[k] is shortened, it is advantageous in that flickering of image that a viewer recognizes is suppressed.

### (2) Second Alternative Embodiment

When the element array area 10 is separated into a plurality of groups B[1] to B[M], the number of rows in each group may be changed arbitrarily. For example, the element array area 10 may be separated into a plurality of groups B[1] to B[M] with two rows of unit circuits U or with four or more rows of unit circuits U However, when the number of rows that belong to each group B[k] is large, it is necessary to sufficiently ensure the peak value of each of the drive control signal GCT[k]. Thus, there will be a problem that a noise that is generated at the time when the level of the drive control signal GCT[k] fluctuates becomes remarkably large and, as a result, it influences the operation of the electro-optical device D. Accordingly, it is desirable that the number of rows that belong to one group B[k] is equal to or less than 25% of the total nugber of rows in the element array area 10 (equal to or less than m/4 rows).

### (3) Third Alternative Embodiment

In the above described embodiment, the drive control transistor QCT is connected between the driving transistor QDR and the electro-optical element E. However, the position of the drive control transistor QCT may be changed where appropriate. For example, as shown in FIG. 20, a configuration in which the drive control transistor QCT is connected between the gate of the driving transistor QDR and the power source line (or the source of the driving transistor QDR) is employed. During a period when the drive control transistor QCT maintains an off state (during the driving period TON[k]), the driving current IDR corresponding to the gate potential of the driving transistor QDR is supplied to the electro-optical element E. In contrast, during a period when the drive control transistor QCT maintains an on state (during the non-driving period TOFF[k]), the driving transistor QDR is in an off state (the voltage between the gate and the source becomes zero). For this reason, the supply of driving current IDR to the electro-optical element E is stopped. That is, the presence or absence of the supply of driving current IDR to the electro-optical element E changes in accordance with the state of the drive control transistor QCT (that is, the drive control signal GCT[k]).

In addition, as shown in FIG. 21, the configuration in which the drive control transistor QCT is arranged in parallel with the electro-optical element E (the configuration in which the drive control transistor QCT is connected between the drain of the driving transistor QDR and the ground line (ground potential Gnd)) may be employed. During a period when the drive control transistor QCT maintains an off state (during the driving period TON[k]), the driving current IDR corresponding to the gate potential of the driving transistor QDR is supplied to the electro-optical element E. In contrast, during a period when the drive control transistor QCT maintains an on state (during the non-driving period TOFF[k]), the driving current IDR flows through the drive control transistor QCT to the ground line. For this reason, the supply of driving current IDR to the electro-optical element E is interrupted (or reduced). That is, in the configuration shown in FIG. 21 as well, the supply of driving current IDR to the electro-optical element E is controlled in accordance with the state of the drive control transistor QCT.

As exemplified above, the drive control transistor QCT of one embodiment only needs to be a switching element that permits the electro-optical element E to operate or that prohibits the electro-optical element E from operating (typically, emission of light owing to the supply of driving current IDR), and its specific configuration and a relation with the other components (for example, the electro-optical element E or the driving transistor QDR) are arbitrary.

### (4) Fourth Alternative Embodiment

The organic light emitting diode and the light receiving element are one of examples of the electro-optical element. Regarding the electro-optical element, it need not to distinguish a selfluminous-type electro-optical element that emits light by itself from a nonluminous-type electro-optical element (for example, liquid crystal element) that changes its transmittance ratio of outside light and also need not to distinguish a current-drive-type electro-optical element that is driven by the supply of electric current from a voltage-drive-type electro-optical element that is driven by the application of voltage. For example, various electro-optical elements, such as an inorganic EL element, a field emission (FE) element, a surface-conduction electron-emitter (SE) element, a ballistic electron surface emitting (BS) element, a LED (light emitting diode) element, a liquid crystal element, an electrophoretic element and an electrochromic element, may be used.

### J: Applications

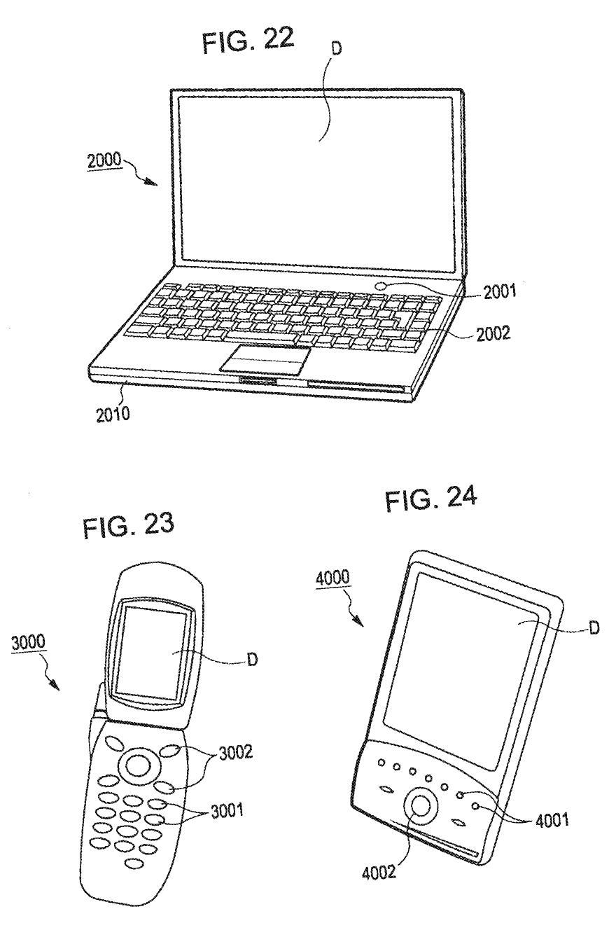

The following will describe an electronic apparatus. FIG. 22 to FIG. 24 show embodiments of electronic apparatuses that employ the above described electro-optical device D as a display device.

FIG. 22 is a perspective view of a configuration of a mobile personal computer that employs the electro-optical device D. A personal computer 2000 includes the electro-optical device D that displays various images and a body portion 2010 in which a power switch 2001 and a keyboard 2002 is installed. Because the electro-optical device D uses an organic light emitting diode element as an electro-optical element E, it is possible to display a screen that has a wide viewing angle and is easy to view.

FIG. 23 is a perspective view of a configuration of a mobile telephone to which the electro-optical device D is applied. A mobile telephone 3000 includes a plurality of operation buttons 3001, a plurality of scroll buttons 3002, and the electro-optical device D that displays various images. By manipulating the scroll buttons 3002, an image displayed on the electro-optical device D is scrolled.

FIG. 24 is a perspective view of a mobile information terminal (PDA: Personal Digital Assistants) to which the electro-optical device D is applied. A mobile information terminal 4000 includes a plurality of operation buttons 4001, a power switch 4002, and the electro-optical device D that displays various images. When the power switch 4002 is manipulated, various pieces of information, such as address book or schedule book is displayed on the electro-optical device D.

Note that the electronic apparatuses that employ the electro-optical device include, in addition to the apparatuses shown in FIG. 22 to FIG. 24, a digital still camera, a television, a video camera, a car navigation system, a pager, an electronic personal organizer, an electronic paper, an electronic calculator, a word processor, a workstation, a video telephone, a POS terminal, a printer, a scanner, a photocopier, a video player, and devices provided with a touch panel display. However, applications of the electro-optical device are not limited to image display. For example, in an electrophotographic image forming apparatus, the electro-optical device may be used as an exposure apparatus that forms a latent image on a photoreceptor drum by means of exposure.

What is claimed is:

1. An electro-optical device comprising:
a plurality of data lines;
a plurality of selection lines;
a plurality of unit circuits, wherein each of the plurality of unit circuits is connected to a corresponding one of the plurality of data lines and a corresponding one of the plurality of selection lines, wherein the plurality of unit circuits form a unit circuit group for each of the selection lines;
a selection circuit that supplies a selection signal to one of the plurality of selection lines so that data signals are written from the plurality of data lines to the corresponding unit circuit group during a selection period when the corresponding unit circuit group is selected; and
a control circuit that supplies a common control signal to the unit circuits included in a group consisting of two or more of the unit circuit groups, wherein the control circuit brings the control signal into a predetermined state during a period that is different from the selection period when any one of the two or more unit circuit groups is selected, wherein
each of the plurality of unit circuits includes:
an electro-optical element;
a first switching element that writes the data signal from one of the plurality of data lines to the corresponding unit circuit in accordance with the selection signal; and
a driving transistor, the gate of which is supplied with a voltage corresponding to the data signal, wherein the driving transistor supplies a driving current to the electro-optical element.

2. The electro-optical device according to claim 1, wherein, when the control signal is in the predetermined state, the states of the unit circuits prior to the selection period are set.

3. The electro-optical device according to claim 2, wherein each of the unit circuits further includes a second switching element that sets a potential of the gate to a predetermined value when the control signal is in the predetermined state.

4. The electro-optical device according to claim 3, wherein the second switching element is electrically connected to a drain of the driving transistor with the gate of the driving transistor when the second switching element enters a conductive state.

5. The electro-optical device according to claim 4, wherein, in each of the unit circuits, the electro-optical element and the driving transistor is connected in series in a line through which the driving current flows from a power source,
each of the unit circuit includes a third switching element provided in a line connected to the power source and a logic circuit that outputs a logic signal based on the control signal and a drive control signal,
the third switching element is controlled on the basis of the logic signal, and
the drive control signal i a signal that specifies a period during which a supply of the driving current corresponding to the written data signal to the electro-optical element is permitted or that specifies a period during which a supply of the driving current corresponding to the written data signal to the electro-optical element is prohibited.

6. The electro-optical device according to claim 5, further comprising:
a regulator circuit that delays the logic signal relative to the control signal.

7. The electro-optical device according to claim 6, wherein the regulator circuit includes:
a predetermined number of buffers arranged in a line through which the control signal is supplied to the second switching element; and
buffers, that are greater in number than the predetermined number, arranged in a line through which the logic signal is supplied to the third switching element.

8. The electro-optical device according to claim 3, further comprising:
a power feed line through which a reset potential is supplied, wherein
the second switching element controls electrical connection between the power feed line and the gate of the driving transistor.

9. The electro-optical device according to claim 1, wherein each of the unit circuits includes a fourth switching element that electrically conducts a line between the electro-optical element and the gate of the driving transistor when the control signal is in the predetermined state.

10. The electro-optical device according to claim 9, further comprising:
a logic circuit that outputs a logic signal based on the selection signal and the control signal, wherein
the fourth switching element is controlled on the basis of the logic signal.

11. The electro-optical device according to claim 10, further comprising:
a regulator circuit that delays the logic signal relative to the selection signal.

12. The electro-optical device according to claim 11, wherein the regulator circuit includes:
a predetermined number of buffers arranged in a line through which the selection signal is supplied to the first switching element; and
buffers, that are greater in number than the predetermined number, arranged in a line through which the logic signal is supplied to the fourth switching element.

13. An electro-optical device comprising:
a plurality of date lines, each of which is supplied with a data signal corresponding to a gray-scale level;
a plurality of selection lines, each of which is supplied with a selection signal;
a plurality of unit circuits, each of which is connected to a corresponding one of the plurality of data lines and a corresponding one of the plurality of selection lines, wherein the plurality of unit circuits form a unit circuit group for each of the selection lines; and
a control line that is commonly connected to the unit circuits included in a group consisting of two or more of the unit circuit groups, wherein
the selection signal specifies the selection period for each of the unit circuit groups so that the data signals are written to the corresponding unit circuit group within the selection period of the corresponding unit circuit group,
a control signal supplied to the control line is set to a predetermined state so that the two or more unit circuit groups are controlled during a period that is different from the period when any one of the two or more unit circuit groups are selected,
each of the plurality of unit circuits includes:
an electro-optical element;
a first switching element that writes the data signal from one of the plurality of data lines to the corresponding unit circuit in accordance with the selection signal; and
a driving transistor, the gate of which is supplied with a voltage corresponding to the data signal, wherein the driving transistor supplies a driving current to the electro-optical element.

14. An electronic apparatus comprising the electro-optical device according to claim 1.

15. An electro-optical device comprising:
a plurality of data lines;
a plurality of selection lines;
a plurality of unit circuits, each of which is connected to a corresponding one of the plurality of data lines and a corresponding one of the plurality of selection lines, wherein the plurality of unit circuits form a unit circuit group for each of the plurality of selection lines;
a selection circuit that supplies a selection signal to one of the plurality of selection lines so that a detection current is supplied from the corresponding unit circuit group to each of the plurality of data lines within a selection period when the corresponding unit circuit group is selected; and
a control circuit that supplies a common control signal to the unit circuits included in a group consisting of two or more of the unit circuit groups, wherein the control circuit brings the control signal into a predetermined state during a period that is different from the selection period when any one of the two or more unit circuit groups is selected, wherein
each of the plurality of unit circuits includes:
an electro-optical element that generates an electrical signal corresponding to the amount of light received;
a detecting transistor that outputs the detection current corresponding to the electrical signal; and
a first switching element that supplies the detection current supplied from the detecting transistor to a corresponding one of the plurality of data lines in accordance with the selection signal.

16. The electro-optical device according to claim 15, wherein each of the unit circuits includes a second switching element that electrically conducts a line between the electro-optical element and a gate of the detecting transistor when the control signal Is in the predetermined state.
